(19) United States
(12) Patent Application Publication
(10) Pub. No.: US 2014/0014721 A1
(43) Pub. Date: Jan. 16, 2014

(54) PROCESSING SERVER AND TRANSFER MANAGEMENT METHOD

(71) Applicant: FUJITSU LIMITED, Kawasaki-shi (JP)

(72) Inventors: Taira SHIMA, Kawasaki (JP); Shoji WAJIMA, Kawasaki (JP); Kohei OSAWA, Kawasaki (JP); Nobutaka YAMAMOTO, Kawasaki (JP); Tadahiko SATO, inagi (JP); Eiji ITOU, Yokohama (JP)

(73) Assignee: FUJITSU LIMITED, Kawasaki (JP)

(21) Appl. No.: 13/935,837

(22) Filed: Jul. 5, 2013

(30) Foreign Application Priority Data
Jul. 11, 2012 (JP) 2012-156001
Mar. 27, 2013 (JP) 2013-067666

(51) Int. Cl. G06K 5/00

(52) U.S. Cl. CPC G06K 5/00
USPC 235/382.5

(57) ABSTRACT

In a server; a ticket allotting unit generates, in response to a first request from a first user, first-type image code and stores the first-type information in a management database (DB) in a manner corresponding to a second user. Moreover, in response to a second request from the first user, generates second-type image code which is different from the first-type image code and stores the second-type image code in the management DB in a manner corresponding to a third user. Then, for example, a QR returning unit invalidates the first-type information stored in the management DB and validates the second-type information stored in the management DB. Then, a QR displaying unit sends the second-type image code to the third user.

### CROSS-REFERENCE TO RELATED APPLICATION

This application is based upon and claims the benefit of priority of the prior Japanese Patent Application No. 2012-156001, filed on Jul. 11, 2012, and the Japanese Patent application No. 2013-067666, filed on Mar. 27, 2013, the entire contents of which are incorporated herein by reference.

### FIELD

The embodiments discussed herein are directed to a processing server and a transfer management method.

### BACKGROUND

In recent years, image code is used as an entry ticket of a concert or an event. Such image code is displayed on the displaying unit of an electronic device, and is checked for authentication purpose. For example, on a handheld device, 2D barcode, such as a quick response (QR) code (registered trademark), is displayed and utilized as an entry ticket.

Since a QR code is an image, it is duplicable in nature. Thus, if a QR code is duplicated, the right to entry may not correspond to the entry tickets on a one-to-one basis. In the case when QR codes are to be displayed as the entry tickets, it becomes difficult to determine the validity of a duplicated QR code. Hence, for example, once the entry procedure with respect to a particular QR code is completed, that QR code is invalidated. Thus, in case the QR code is duplicated, the user who possesses the QR code having the same contents and who is second to enter is not allowed to enter regardless of whether that user possesses the pre-duplication legitimate QR code. Particularly, regarding an entry ticket for which a QR code transferred from a third user is displayed; if the user who had transferred the QR code enters earlier, then the user who has received the transferred QR code cannot use the transferred entry ticket anymore irrespective of possessing the legitimate QR code.

A conventional technology is known in which, in the case of transferring an online ticket, the user transferring the ticket and the user receiving the transferred ticket perform the transfer through a server. With that, a new online ticket is issued to the user who receives the transferred ticket, and the online ticket of the user who transferred it is invalidated (for example, Japanese Laid-open Patent Publication No. 2002-269279).

However, in the case of computerized entry tickets, although the purchaser of an entry ticket is linked to that entry ticket, he or she is not allowed to uniquely manage the transfer of that entry ticket. For example, in the conventional technology, once an online ticket is transferred, the user who transferred the ticket is not allowed to get involved in any further transfer of that online ticket to a still new user. That is, once an entry ticket is transferred by the purchaser thereof, he or she is not allowed to transfer the same entry ticket again to a different user.

Moreover, there is also a possibility that a QR code which has already been transferred gets duplicated, and thus the corresponding entry ticket loses its uniqueness.

### SUMMARY

According to an aspect of an embodiment, a computer readable storage medium stores a transfer managing program. The transfer managing program causes a computer to execute a process. The process includes generating, in response to a first request from a first user, first image code. The process includes storing the first image code in a memory in a manner corresponding to a second user. The process includes generating, in response to a second request from the first user, second image code which is different from the first image code. The process includes storing the second image code in the memory in a manner corresponding to a third user. The process includes controlling, in response to a third request from the first user that requires invalidating the first image code and validating the second image code. And the process includes sending the second image code to the third user.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a ticket transfer managing system according to a first embodiment;

FIG. 2 is a diagram illustrating an exemplary data structure of a management database (DB) according to the first embodiment;

FIGS. 3A and 3B are flowcharts for explaining a ticket allotting operation according to the first embodiment;

FIG. 4 is a flowchart for explaining a QR returning operation according to the first embodiment;

FIG. 5 is a flowchart for explaining a QR displaying operation according to the first embodiment;

FIGS. 6A and 6B are a sequence diagram for explaining a sequence of operations performed during a ticket transfer managing operation in the case of a normal transfer;

FIGS. 7A and 7B are a sequence diagram for explaining a sequence of operations performed during the ticket transfer managing operation in the case of no returning approval by the user from whom a ticket is to be transferred;

FIGS. 8A and 8B are sequence diagrams for explaining a sequence of operations performed during the ticket transfer managing operation in the case when the user to whom a ticket is to be transferred does not obtain the ticket;

FIGS. 9A and 9B are sequence diagrams for explaining a sequence of operations performed during the ticket transfer managing operation in the case of transferring the right of the user who has not obtained a ticket;

FIGS. 10A and 10B are a diagram illustrating transition of data in the case of a normal transfer;

FIG. 11 is a diagram illustrating transition of data in the case of no returning approval by the user from whom a ticket is to be transferred;

FIGS. 12A and 12B are a diagram illustrating transition of data in the case of in the case of transferring the right of the user who has not obtained a ticket;

FIGS. 13A and 13B are a diagram for explaining the transition of screens that occurs during the ticket transfer management according to the first embodiment;

FIG. 14 is a diagram illustrating an example of a QR information input screen;

FIG. 15 is a diagram illustrating an example of a QR transmission information input screen;

FIG. 16 is a diagram illustrating an example of a QR transmission confirmation screen;

FIG. 17 is a diagram illustrating an example of a QR transmission completion screen;

FIG. 18 is a diagram illustrating an example of a transmission error email;

FIG. 19 is a diagram illustrating an example of a QR acquisition email;

FIG. 20 is a diagram illustrating an example of a QR acquisition screen;

FIG. 21 is a diagram illustrating an example of the QR transmission information input screen in the case of changing the users to whom the tickets are to be allotted;

FIG. 22 is a diagram illustrating an example of a QR returning email;

FIG. 23 is a diagram illustrating an example of a QR returning approval screen;

FIG. 24 is a diagram illustrating an example of a returning completion screen;

FIG. 25 is a diagram illustrating an example of a QR acquisition URL invalidation email;

FIG. 26 is a block diagram illustrating an overview of a ticket transfer managing system according to a second embodiment;

FIGS. 27A and 27B are flowcharts for explaining a ticket cancelling operation according to the second embodiment;

FIGS. 28A, 28B, 28C and 28D are sequence diagrams for explaining a sequence of operations performed in the case when the ticket cancelled by a possessor could be transferred to a new purchaser;

FIGS. 29A, 29B, 29C and 29D are sequence diagrams for explaining a sequence of operations performed in the case when a possessor cancels the ticket but then drops the ticket cancellation request;

FIGS. 30A, 30B, 30C and 30D are sequence diagrams for explaining a sequence of operations performed in the case when the ticket cancelled by a possessor could not be transferred to a new purchaser;

FIGS. 31A and 31B are a diagram illustrating transition of data in the case when the ticket cancelled by a possessor could be transferred to a new purchaser;

FIGS. 32A, 32B and 32C are a diagram illustrating transition of data in the case when a possessor cancels the ticket but then drops the ticket cancellation request; and

FIGS. 33A, 33B and 33C are a diagram illustrating transition of data in the case when the ticket cancelled by a possessor could not be transferred to a new purchaser.

### DESCRIPTION OF EMBODIMENTS

Preferred embodiments of the present invention will be explained with reference to accompanying drawings. However, the present invention is not limited to the embodiments described herein.

### [a] First Embodiment

Configuration of Ticket Transfer Managing System

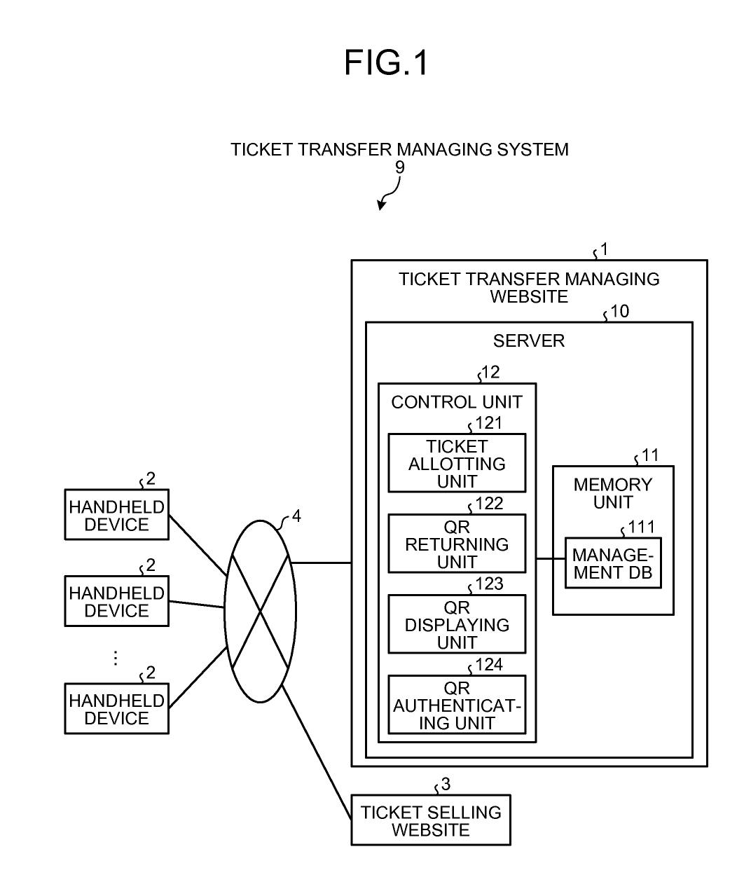

FIG. 1 is a diagram illustrating an overview of a ticket transfer managing system according to a first embodiment. As illustrated in FIG. 1, a ticket transfer managing system 9 includes a ticket transfer managing website 1, handheld devices 2, and a ticket selling website 3. The ticket transfer managing website 1 is connected to a plurality of handheld devices 2 and to the ticket selling website 3 via a network 4 such as the Internet network.

The ticket selling website 3 is responsible for the sale of tickets. That is, the ticket selling website 3 sells tickets in response to ticket purchasing requests issued from the handheld devices 2 of the users. While selling a ticket, the ticket selling website 3 sends an email (called “QR distribution email”), which indicates that the QR code to be used for authentication purpose at the entry has been distributed, to the address of the handheld device 2 of the user who had issued the ticket purchasing request (i.e., the handheld device 2 of the purchaser). A QR distribution email includes, for example, a uniform resource locator (URL) at which the QR code is issued (called “QR issuing URL”); a confirmation number; and a password A. Meanwhile, the ticket selling website 3 sends purchase information of tickets to the ticket transfer managing website 1. The purchase information contains, for example, seat information; purchaser information; and a password (hereinafter, called “password A”) given to the purchaser.

Meanwhile, the code used for authentication purpose at the entry is not limited to a QR code. Alternatively, it is also possible to use a one-dimensional barcode, or a two-dimensional barcode, or image code that is electronically displayable on the handheld device 2 of the user. However, the following explanation is given under the assumption that the code used for authentication purpose at the entry is a QR code.

Each handheld device 2 can be a cellular telephone having a connection environment for connecting with the network 4, or can be a personal digital assistant (PDA) having a browser for connecting with the network 4. Moreover, each handheld device 2 has a monitor on which is displayed the QR code used for authentication purpose at the entry.

The ticket transfer managing website 1 manages the transfer of tickets. More particularly, the ticket transfer managing website 1 includes a server 10 that, for example, implements a web service for managing the transfer of tickets. Herein, the transfer of a ticket means the transfer of an entry ticket of a predetermined event as well as the transfer of seat information. Meanwhile, the seat information is not limited to a reserved seat, but can also indicate a non-reserved seat.

The server 10 includes a memory unit 11 and a control unit 12.

The memory unit 11 is a nonvolatile semiconductor memory device such as a flash memory or an FRAM (registered trademark) (FRAM stands for Ferroelectric Random Access Memory). Moreover, the memory unit 11 stores therein a management database (DB) 111, which is used in managing the transfer of tickets. In the management DB 111; QR code information, seat information, and user information is stored in a corresponding manner. The data structure of the management DB 111 is described later.

The control unit 12 includes an internal memory for storing computer programs, in which various operation sequences are defined, or for storing control data. The control unit 12 performs various operations using such information. Moreover, for example, the control unit 12 is an integrated circuit such as an application specific integrated circuit (ASIC) or a field programmable gate array (FPGA); or is an electronic circuit such as a central processing unit (CPU) or a micro processing unit (MPU). Furthermore, the control unit 12 includes a ticket allotting unit 121, a QR returning unit 122, a QR displaying unit 123, and a QR authenticating unit 124.

In response to a ticket allotment request issued by the purchaser of the to-be-allotted tickets, the ticket allotting unit 121 generates a QR code corresponding to each ticket and stores the QR code in the management DB 111 in a corresponding manner to the user (including the purchaser) to whom that ticket is to be allotted. Herein, in the management DB 111, the ticket allotting unit 121 stores QR code information and seat information in a corresponding manner to the user information of the user to whom each ticket is to be allotted. Meanwhile, with respect to a particular ticket, the QR code generated for the first time is a valid QR code. The validity of a QR code indicates that the ticket corresponding to that QR code is valid; and means that the corresponding ticket can be possessed, that is, means that the QR code can be obtained. On the other hand, invalidity of a QR code indicates that the ticket corresponding to that QR code is invalid; and means that the corresponding ticket is not allowed to be possessed, that is, means that the QR code is not allowed to be obtained. Then, to the address of the handheld device 2 of each user to whom a QR code has been allotted, the ticket allotting unit 121 sends an email (called “QR acquisition email”) to prompt that user to obtain the corresponding QR code. A QR acquisition email includes, for example, a uniform resource locator (URL) at which the QR code is obtained (called “QR acquisition URL”); a confirmation number; and a password used for authentication purpose at the time of obtaining the generated QR code.

Meanwhile, in response to a ticket allotment request that is issued by a purchaser regarding a ticket that has already been allotted, the ticket allotting unit 121 generates a different QR code than the already-generated QR code and stores the newly-generated QR code in the management DB 111 in a corresponding manner to the user of the new ticket. This is done in the case in which, after the purchaser has allotted a particular ticket, he or she wishes to the allotted ticket to a different user. Herein, in the management DB 111, the ticket allotting unit 121 stores QR code information and seat information in a corresponding manner to the user information of the user to whom the ticket is newly allotted. Then, the ticket allotting unit 121 sends a QR acquisition email to the address of the handheld device 2 of the user to whom the ticket is newly allotted. At that time, if the user to whom the ticket was originally allotted has already obtained the corresponding QR code, then the ticket allotting unit 121 sends an email (called “QR returning email”) to the address of the handheld device 2 of that user. On the other hand, if the user to whom the ticket was originally allotted has not yet obtained the corresponding QR code, then the ticket allotting unit 121 sends an email (called “URL invalidation email”), which indicates that the QR acquisition URL sent to that user is invalidated, to the address of the handheld device 2 of that user. That is done in order to invalidate the QR code of the user to whom the ticket was originally allotted. Meanwhile, the details regarding the ticket allotting unit 121 are described later.

When an approval for returning the QR code is received from the handheld device 2 of the user to whom the ticket was originally allotted, the QR returning unit 122 invalidates that QR code and validates the QR code of the user to whom the ticket is newly allotted. Meanwhile, the details regarding the QR returning unit 122 are described later.

When a QR code acquisition request is received from the handheld device 2 of the user to whom a ticket has been allotted; if the QR code of the user to whom that ticket was originally allotted is invalidated, then the QR displaying unit 123 stores, in the management DB 111, the value obtained by adding one to the number of times of obtaining the QR code newly allotted to the user. Then, the QR displaying unit 123 displays the obtained QR code on the monitor of the handheld device 2 of the user to whom the ticket has been newly allotted. That is, if the user to whom the ticket was originally allotted has returned the corresponding QR code, the QR displaying unit 123 can display the QR code of the user to whom the ticket has been newly allotted on the monitor of the handheld device 2 of that user. Thus, the QR code that is displayed on the handheld device 2 of the user to whom the ticket has been newly allotted is used for authentication at the time of entry of that user. Meanwhile, there may be times when the user to whom a ticket has been allotted mistakenly deletes the displayed QR code. In that regard, the configuration can be such that the user to whom a ticket has been allotted is allowed to repeatedly obtain the same QR code for a predetermined number of times. The details regarding the QR displaying unit 123 are described later.

At the time of the entry of a user, the QR authenticating unit 124 performs authentication using the QR code displayed on the handheld device 2 of that user. For example, the QR authenticating unit 124 receives the QR code from a reading device (not illustrated), which reads the QR code displayed on the handheld device 2 of the user. Then, the QR authenticating unit 124 cross-checks the received QR code against QR images linked inside the management DB 111 (described later); and authenticates the QR code of the user. If the received QR code matches with a QR image, then the QR authenticating unit 124 notifies the reading device about the permission of entry. With that, the user becomes able to enter the event. On the other hand, if the received QR code does not match with any QR image, then the QR authenticating unit 124 notifies the reading device about disallowing the entry. Hence, the user does not enter the event.

Data Structure of Management DB

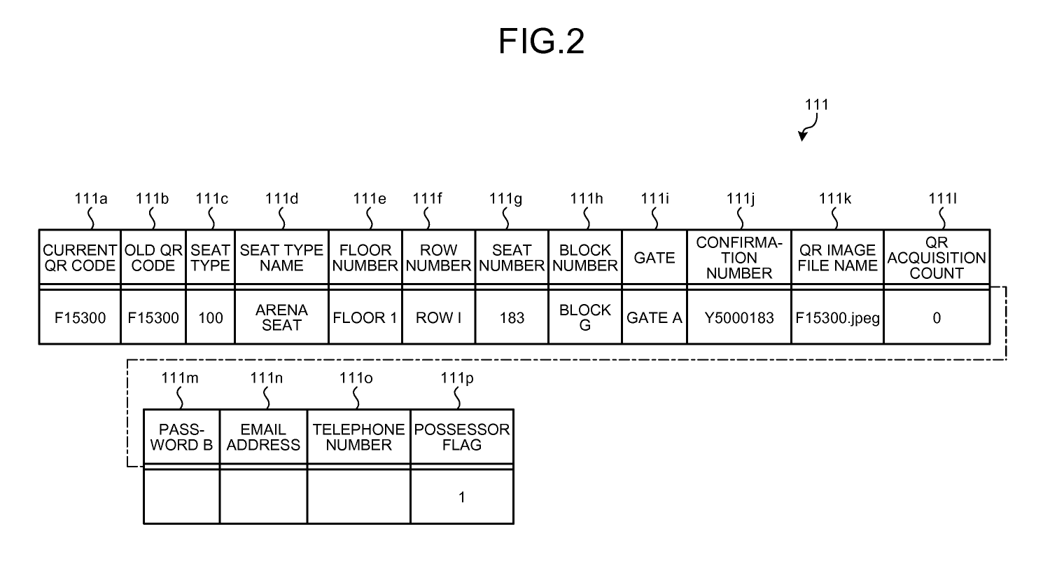

Explained below with reference to FIG. 2 is a data structure of the management DB 111. FIG. 2 is a diagram illustrating an exemplary data structure of the management DB 111 according to the first embodiment. As illustrated in FIG. 2, the management DB 111 includes the following fields: current QR code 111a; old QR code 111b; seat type 111c; seat type name 111d; floor number 111e; row number 111f; seat number 111g; block number 111h; gate 111i; confirmation number 111j; QR image file name 111k; QR acquisition count 111l; password B 111m; email address 111n; telephone number 111o; and possessor flag 111p.

The current QR code 111a indicates the contents of the current QR code. The old QR code 111b indicates the contents of the QR code that was generated for the first time. The seat type 111c indicates a code representing the type of seat. The seat type name 111d indicates the name of the type of seat. The floor number 111e indicates the number of the floor at which the seat is present. The row number 111f indicates the number of the row in which the seat is present. The seat number 111g indicates the number of the seat. Thus, the floor number 111e, the row number 111f, and the seat number 111g collectively represent a unique set of seat information. Hence, when a purchaser transfers the ticket having such seat information, the current QR code 111a corresponding to the user to whom the ticket is transferred is set to a different QR code than the QR code corresponding to the original purchaser.

The block number 111h indicates, when the seats are grouped into blocks, the number of the block in which the seat is present. The gate 111i indicates the entry gate. The confirmation number 111j indicates the confirmation number issued at the time of purchasing the ticket. The QR image file name 111k indicates the name of the file in which the QR image is stored. The QR acquisition count 111l indicates the number of times of obtaining the same QR code. The password B 111m indicates the password used for authentication purpose at the time of obtaining the QR code. The email address 111n indicates the email address of the user. The telephone number 111o indicates the telephone number of the user, and is used along with the password B 111m for authentication purpose at the time of obtaining the QR code. The possessor flag 111p is a flag related to the possessor of the ticket. For example, in the possessor flag 111p, “0” is set to indicate that the ticket is not possessed; “1” is set to indicate that the ticket can be possessed; and “9” is set to indicate release of the ticket from possession.

As an example, the content of the management DB 111 is illustrated in the case in which a ticket purchased by a purchaser is not yet allotted. Consider a case in which the confirmation number 111j is “Y5000183”, the floor number 111e is “floor 1”, the row number 111f is “row I”, and the seat number 111g is “183”. In that case, “F15300” is stored as the current QR code 111a; “F15300” is stored as the old QR code 111b; “100” is stored as the seat type 111c; “arena seat” is stored as the seat type name 111d; “block G” is stored as the block number 111h, “gate A” is stored as the gate 111i; “F15300.jpeg” is stored as the QR image file name 111k; “0” is stored as the QR acquisition count 111l; and “1” is stored as the possessor flag 111p. However, the user information of the user to whom the ticket is allotted is not yet stored. That is, the password B 111m, the email address 111n, and the telephone number 111o have no data stored therein yet.

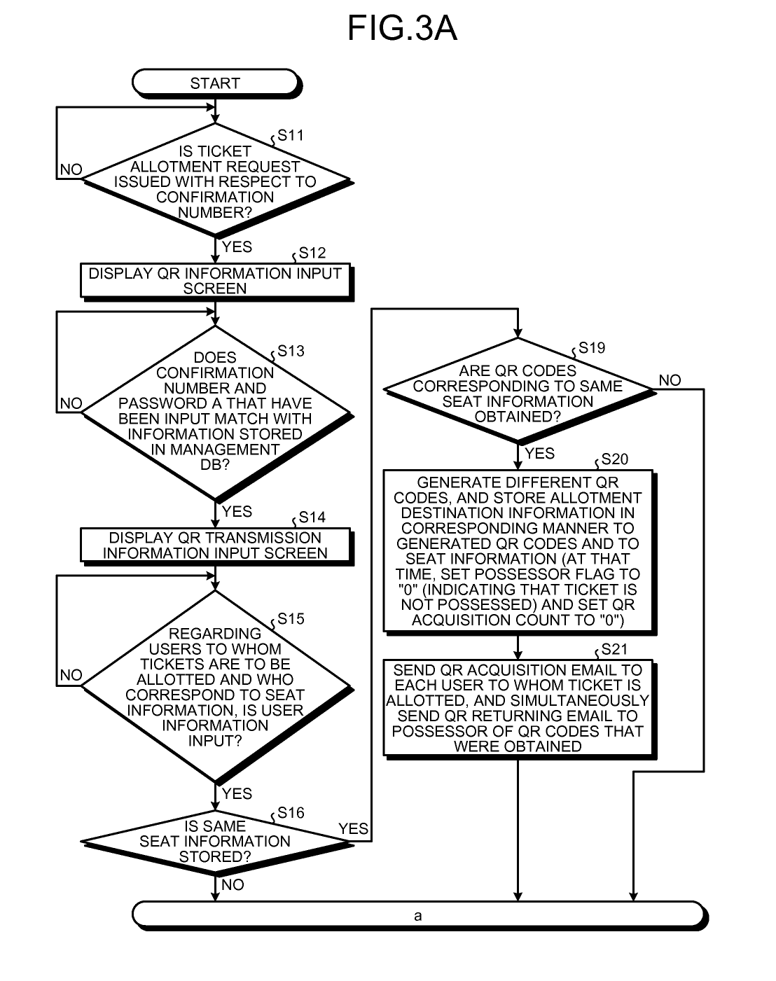

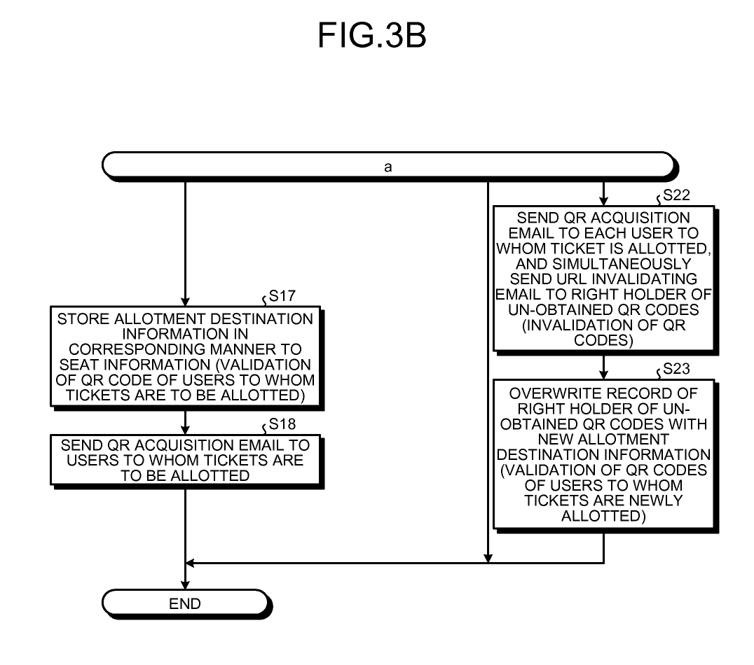

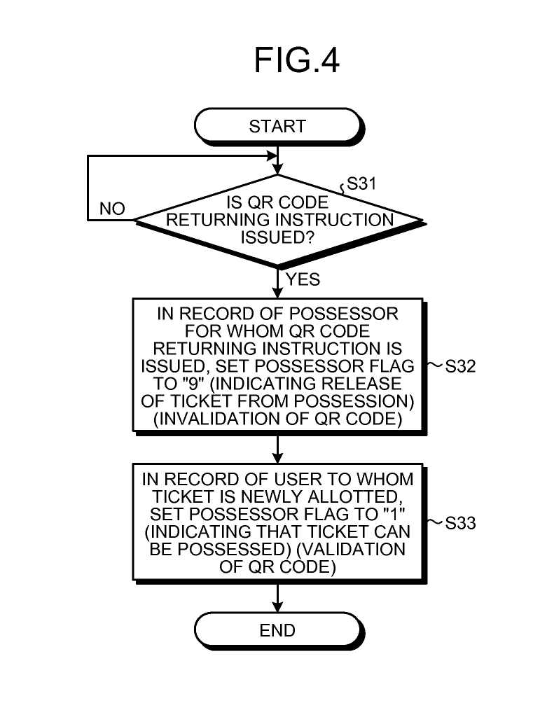

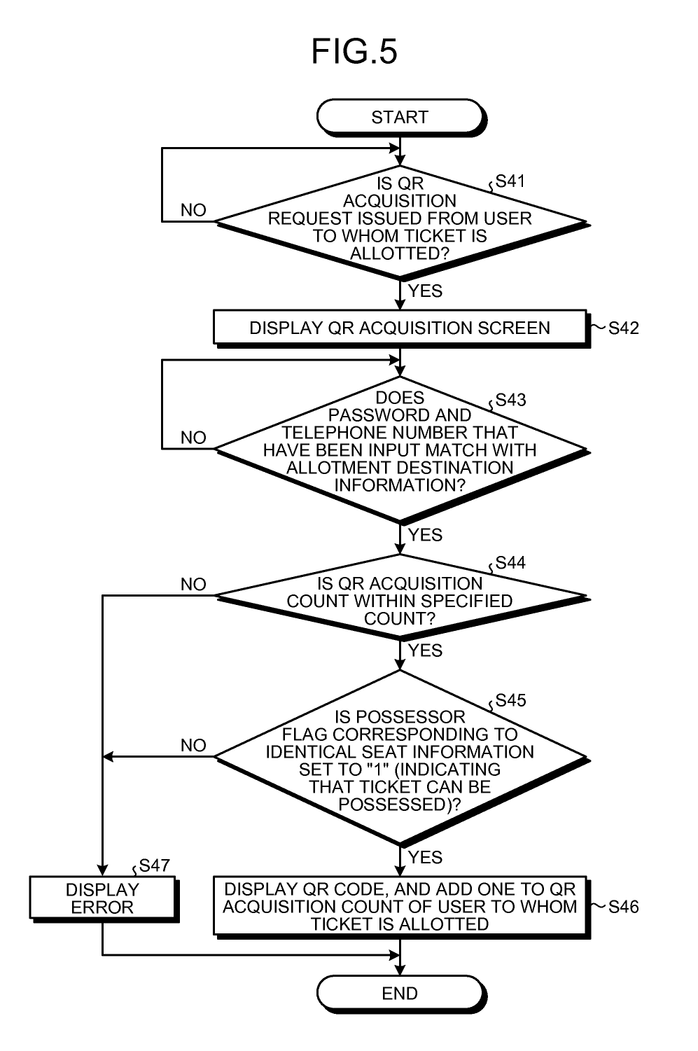

Explained below with reference to FIGS. 3 to 5 are flowcharts for explaining the operations performed during the ticket transfer management according to the first embodiment. FIGS. 3A and 3B are flowcharts for explaining a ticket allotting operation. FIG. 4 is a flowchart for explaining a QR returning operation. FIG. 5 is a flowchart for explaining a QR displaying operation. Herein, in the handheld device 2 of the purchaser of tickets is stored the QR distribution email sent from the ticket selling website 3. That QR distribution email contains the QR issuing URL, the confirmation number at the time of purchasing the tickets, and the password A. Moreover, in the management DB 111 is stored the seat information and the confirmation number as ticket purchasing information. Also, in the management DB 111 is stored, for each set of seat information, the QR code generated for the first time, the possessor flag “1” (indicating that the ticket can be possessed), and the QR acquisition count “0”.

Flowchart for Explaining Ticket Allotting Operation

As illustrated in FIGS. 3A and 3B, the ticket allotting unit 121 determines whether or not a ticket allotment request has been issued with respect to the confirmation number (Step S11). That is, the ticket allotting unit 121 determines whether or not the QR issuing URL was used to access the QR codes. If it is determined that a ticket allotment request has not been issued with respect to the confirmation number (No at Step S11), then the ticket allotting unit 121 repeatedly performs the determination operation until a ticket allotment request is issued.

On the other hand, when it is determined that a ticket allotment request is issued with respect to the confirmation number (Yes at Step S11), the ticket allotting unit 121 displays a QR information input screen (Step S12). The QR information input screen is used in authenticating the purchaser by asking him or her to input the information used for authentication purpose, such as the confirmation number and the password A, from the corresponding handheld device 2. Herein, it is desirable to configure the ticket allotting unit 121 in such a way that, although a ticket allotment request is issued with respect to the confirmation number, the tickets are not allotted after the elapse of a predetermined point of time regarding the ticket allotment request. For example, if the clock turns 0:00 on the day on which the tickets are to be used to enter the event; then the ticket allotting unit 121 displays an error indicating that the tickets are not allotted.

Subsequently, the ticket allotting unit 121 determines whether or not the confirmation number and the password A that have been input match with the information stored in the management DB 111 (Step S13). If it is determined that the input information does not match with the information stored in the management DB 111 (No at Step S13), then the ticket allotting unit 121 repeatedly performs the determination operation until the input information matches.

On the other hand, when it is determined that the input information matches with the information stored in the management DB 111 (Yes at Step S13), the ticket allotting unit 121 determines that the purchaser is legitimate and displays a QR transmission information input screen (Step S14). Herein, the QR transmission information input screen is used in allotting the purchased tickets to the users to whom the tickets are to be allotted. In the QR transmission information input screen; for each set of the sets of seat information corresponding to the tickets, user information of the user to whom the ticket is to be allotted is input from the handheld device 2 of the purchaser. The QR transmission information input screen is used in the case of inputting for the first time the users to whom the tickets are to be allotted, as well as in the case of transferring an allotted ticket to a different user. Meanwhile, each set of seat information is, for example, the information related to a seat that is represented by the floor number, the row number, and the seat number. Each set of user information points to, for example, the telephone number and the email address of a user. Herein, the telephone number of a user may be substituted for the screen name of that user, or a test word, or identification information that is identifiable by that user and the purchaser.

Subsequently, the ticket allotting unit 121 determines whether or not sets of user information of the users, to whom the tickets are to be allotted, corresponding to the sets of seat information are input (Step S15). If it is determined that the sets of user information corresponding to the sets are seat information are not input (No at Step S15), then the ticket allotting unit 121 repeatedly performs the determination operation until such user information is input.

On the other hand, when it is determined that the sets of user information corresponding to the sets of seat information are input (Yes at Step S15), the ticket allotting unit 121 determines whether or not the identical sets of seat information is stored in the management DB 111 (Step S16). If it is determined that the identical sets of seat information are not stored in the management DB (No at Step S16), then the ticket allotting unit 121 stores the sets of user information of the users, to whom the tickets are to be allotted, in a corresponding manner to the sets of seat information (Step S17). With that, the ticket allotting unit 121 validates the QR codes that are generated for the first time with respect to the sets of seat information. Meanwhile, in the management DB 111, each set of user information corresponds to, for example, the telephone number 111o and the email address 111n. Moreover, in the management DB 111, each set of seat information corresponds to, for example, the floor number 111e, the row number 111f, and the seat number 111g.

Then, the ticket allotting unit 121 sends a QR acquisition email to the email address of each user to whom a ticket is allotted (Step S18); and ends the ticket allotting operation.

Meanwhile, if it is determined that the identical sets of seat information are stored in the management DB 111 (Yes at Step S16), then the ticket allotting unit 121 determines whether or not the QR codes corresponding to the identical sets of seat information have been obtained (Step S19). Herein, whether or not a QR code has been obtained is determined according to the values of the possessor flag 111p and the QR acquisition count 111l in the corresponding set of identical seat information. When the possessor flag 111p is set to “1” (indicating that the ticket can be possessed) and the QR acquisition count 111l is greater than “0”, the QR code is determined to have been obtained. On the other hand, when the possessor flag 111p is set to “1” (indicating that the ticket can be possessed) but the QR acquisition count 111l is “0”, the QR code is determined to not have been obtained.

If the QR codes are determined to have been obtained (Yes at Step S19), then the ticket allotting unit 121 generates different QR codes than the QR codes corresponding to the identical sets of seat information. Moreover, the ticket allotting unit 121 stores sets of allotment destination information in a corresponding manner to the generated QR codes and the sets of seat information (Step S20). At that time, the ticket allotting unit 121 sets “0” in the possessor flag 111p (indicating that the ticket is not possessed) and sets the QR acquisition count 111l to “0”.

Subsequently, the ticket allotting unit 121 sends a QR acquisition email to the address of each user to whom a ticket is allotted as well as simultaneously sends a QR returning email to the possessor of the QR codes that were obtained (Step S21). That is, the ticket allotting unit 121 sends an email to each user to whom an already-allotted ticket is transferred and prompts that user to obtain the corresponding QR code, as well as simultaneously sends an email to the user who allotted the tickets (i.e., the user who transferred the tickets) and prompts that user to return the QR codes. Then, the ticket allotting unit 121 ends the ticket allotting operation.

Meanwhile, if the QR codes are determined to not have been obtained (No at Step S19), then the ticket allotting unit 121 sends a QR acquisition email to the email address of each user to whom a ticket is allotted. At the same time, the ticket allotting unit 121 sends a URL invalidation email to the email address of the right holder of the un-obtained QR codes (Step S22). With that, the ticket allotting unit 121 invalidates the QR codes not obtained with respect to the sets of seat information under consideration.

Subsequently, the ticket allotting unit 121 overwrites the record of the right holder of the un-obtained QR codes with the user information of the users to whom the tickets are newly allotted (Step S23). As a result, with respect to the sets of seat information under consideration, the ticket allotting unit 121 validates the QR codes of the users to whom the tickets are newly allotted. Then, the ticket allotting unit 121 ends the ticket allotting operation.

Flowchart for Explaining QR Returning Operation

As illustrated in FIG. 4, the QR returning unit 122 determines whether or not a QR code returning instruction (returning approval) has been issued (Step S31). If it is determined that the QR code returning instruction has not been issued (No at Step S31), then the QR returning unit 122 repeatedly performs the determination operation until a QR code returning instruction is issued.

On the other hand, when it is determined that a QR code returning instruction has been issued (Yes at Step S31), the QR returning unit 122 sets the possessor flag 111p to “9” (indicating release of the ticket from possession) in the record of the possessor for whom the QR code returning instruction is issued (Step S32). With that, the QR returning unit 122 invalidates the QR code corresponding to that possessor.

Then, the QR returning unit 122 sets the possessor flag 111p to “1” (indicating that the ticket can be possessed) in the record of the user to whom the ticket is newly allotted (Step S33). With that, the QR returning unit 122 validates the QR code corresponding to the user to whom the ticket is newly allotted. Then, the QR returning unit 122 ends the QR returning operation.

Flowchart for Explaining QR Displaying Operation

As illustrated in FIG. 5, the QR displaying unit 123 determines whether or not a QR acquisition request is issued from the user to whom a ticket is allotted (Step S41). That is, the QR displaying unit 123 determines whether or not the QR issuing URL was used to access the QR code. If it is determined that a QR acquisition request is not issued (No at Step S41), then the QR displaying unit 123 repeatedly performs the determination operation until a QR acquisition request is issued.

On the other hand, when it is determined that a QR acquisition request is issued (Yes at Step S41), the QR displaying unit 123 displays a QR acquisition screen (Step S42). Herein, the QR acquisition screen is used in authenticating the user to whom the ticket is allotted. Then, the user to whom the ticket is allotted is asked to input information used for authentication purpose, such as the password B and the telephone number, from the handheld device 2 on which the QR acquisition request is displayed.

Then, the QR displaying unit 123 determines whether or not the password B and the telephone number that are input by the user to whom the ticket is allotted match with the allotment destination information stored in the management DB 111 (Step S43). If it is determined that the input information does not match with the allotment destination information stored in the management DB 111 (No at Step S43), then the QR displaying unit 123 repeatedly performs the determination operation until the input information matches.

On the other hand, when it is determined that the input information matches with the allotment destination information stored in the management DB 111 (Yes at Step S43), the QR displaying unit 123 determines whether or not the user to whom ticket is allotted is legitimate. Then, the QR displaying unit 123 determines whether or not the QR acquisition count 111l is within a specified count (Step S44). If it is determined that the QR acquisition count 111l is within the specified count (Yes at Step S44), then the QR displaying unit 123 determines whether or not the possessor flag 111p corresponding to the identical set of seat information is set to “1” (indicating that the ticket can be possessed) (Step S45).

If it is determined that the possessor flag 111p corresponding to the identical set of seat information is set to “1” (indicating that the ticket can be possessed) (Yes at Step S45), then the QR displaying unit 123 displays on a page the QR code corresponding to the user to whom the ticket is allotted. Then, in the record of the user to whom the ticket is allotted, the QR displaying unit 123 sets a value obtained by adding one to the QR acquisition count 111l (Step S46). With that, the possessor of the seat information under consideration becomes the user to whom the ticket is allotted and who has issued the QR acquisition request. Then, the QR displaying unit 123 ends the QR displaying operation.

Meanwhile, if it is determined that the QR acquisition count 111l is greater than the specified count (No at Step S44), or it if is determined that the possessor flag 111p corresponding to the identical set of seat information is not set to “1” (not indicating that the ticket can be possessed) (No at Step S45); then the QR displaying unit 123 displays an acquisition error (Step S47). For example, if the QR acquisition count 111l is greater than the specified count, then the QR displaying unit 123 displays the fact that the QR acquisition count 111l is exceeding the specified count. Moreover, if the possessor flag 111p corresponding to the identical set of seat information is not set to “1” (not indicating that the ticket can be possessed), then the QR displaying unit 123 displays the fact that the old ticket corresponding to the identical set of seat information is not yet returned. Then, the QR displaying unit 123 ends the QR displaying operation.

Sequence of Operations Performed During Ticket Transfer Managing Operation in Case of Normal Transfer

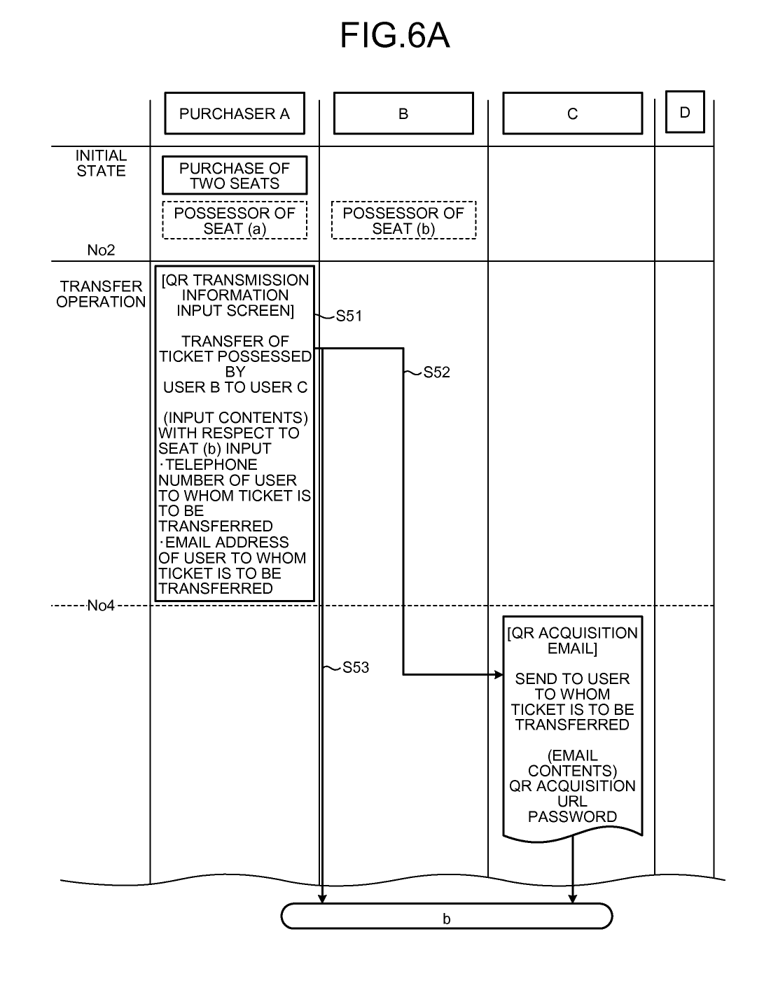

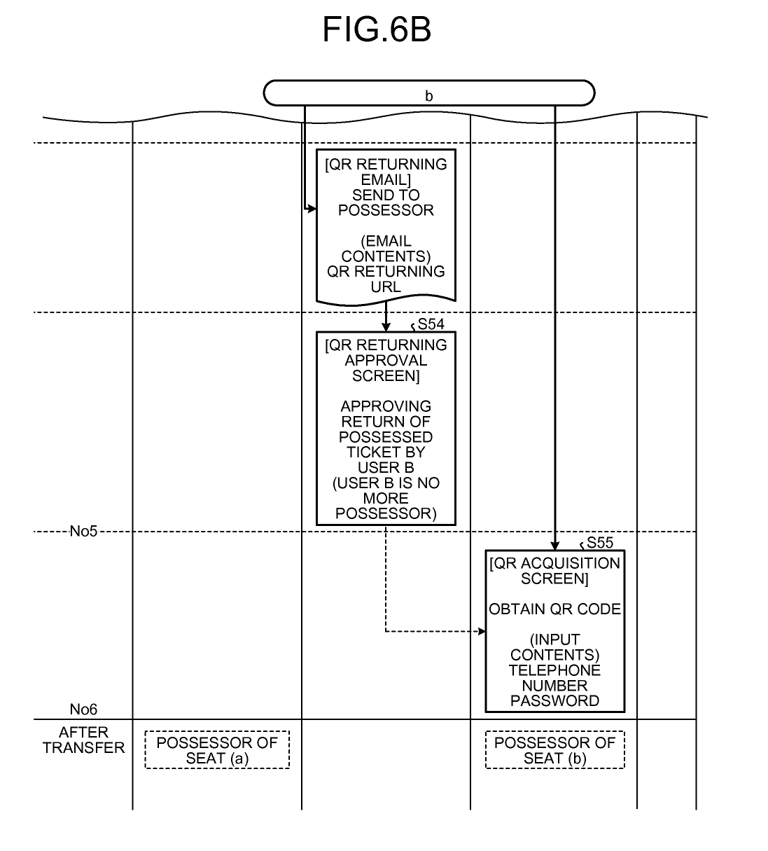

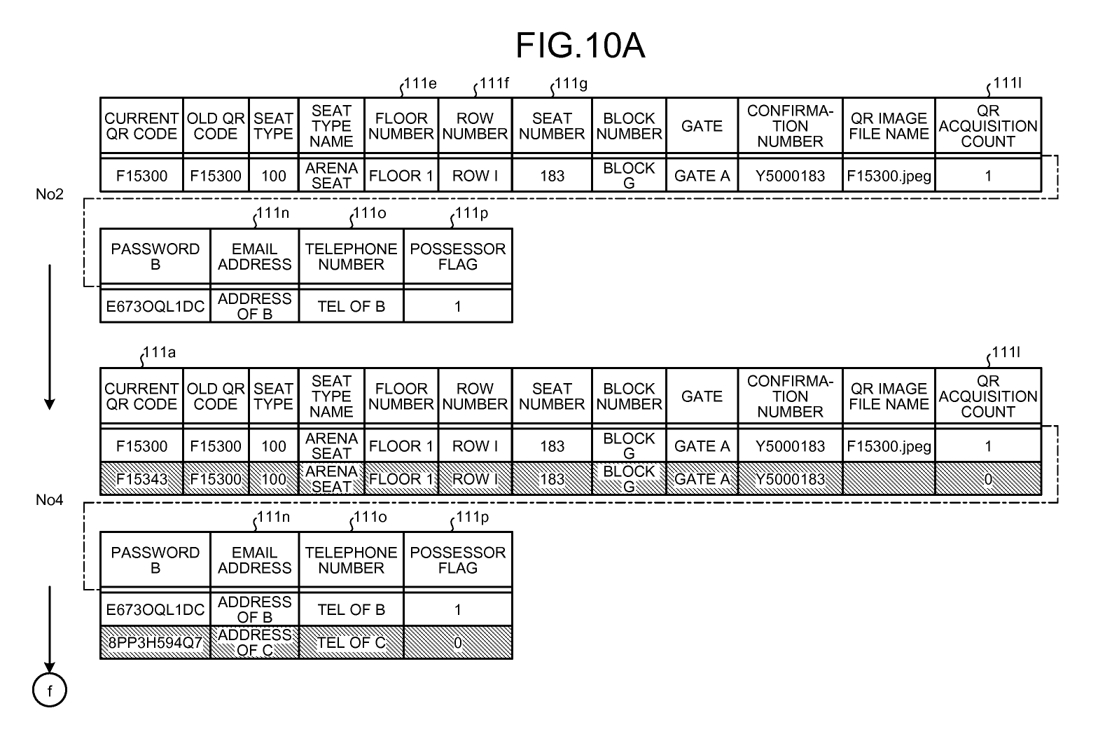

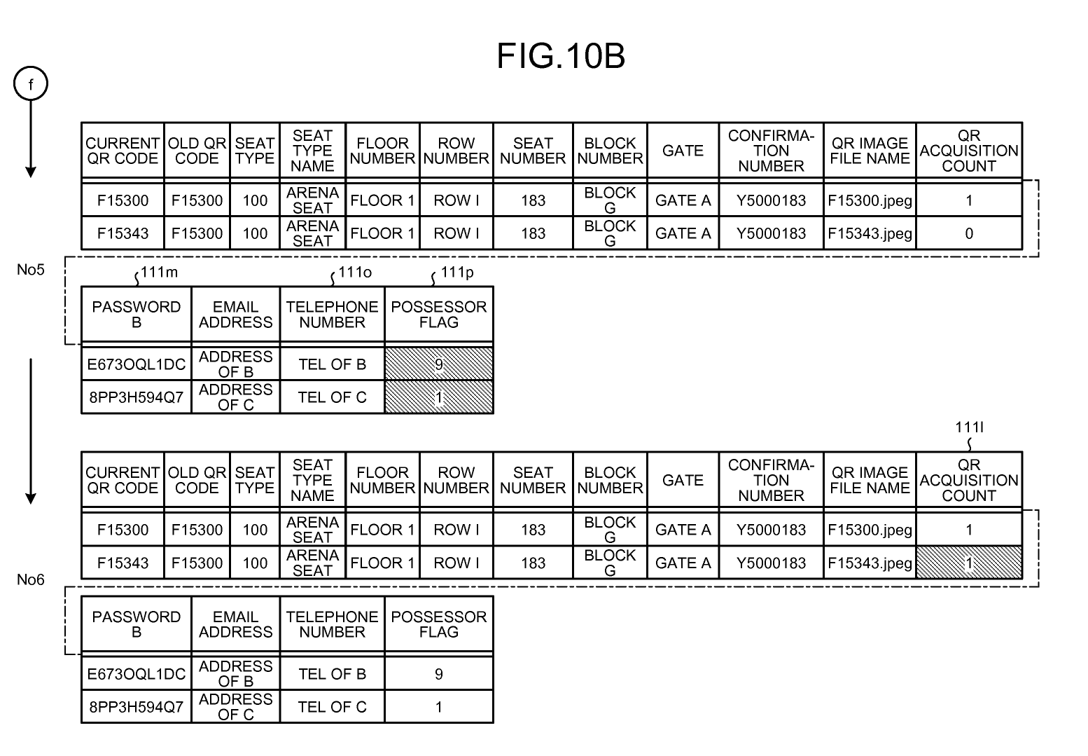

A sequence of operations performed during a ticket transfer managing operation in the case of a normal transfer is explained below with reference to the database content of the management DB 111. FIGS. 6A and 6B are a sequence diagram for explaining a sequence of operations performed during the ticket transfer managing operation in the case of a normal transfer. With reference to FIGS. 6A and 6B, it is assumed that a purchaser A purchases two seats; and that the purchaser A becomes the possessor of a seat a and a user B to whom a seat b is allotted becomes the possessor of the seat b. The following explanation is given for a case in which the purchaser A transfers the seat b, which is allotted to the user B, to a user C to whom a ticket is to be allotted. Meanwhile, the following explanation is given with reference to the record of the seat b maintained in the management DB 111 as illustrated in FIG. 10.

When the authentication of the purchaser A is successful, the ticket allotting unit 121 displays the QR transmission information input screen (Step S51).

At that point of time, in the record of the seat b maintained in the management DB 111, “address of B” is set in the email address 111n; “TEL of B” is set in the telephone number 111o; “1” is set in the possessor flag 111p (indicating that the ticket can be possessed); and “1” is set in the QR acquisition count 111l (see No2 in FIG. 10).

From the QR transmission information input screen; the purchaser A inputs the telephone number and the email address of the user to whom the seat b is to be transferred. Since the possessor flag 111p corresponding to the seat b is set to “1” and since the QR acquisition count 111l corresponding to the seat b is “1”, the ticket allotting unit 121 determines that the corresponding QR code has been obtained. Hence, in the management DB 111, the ticket allotting unit 121 adds the record of the user C, to whom the seat b is to be allotted, corresponding to the seat b.

In the newly-added record in the management DB 111, “F15343” is set in the newly-generated current QR code 111a; “address of C” is set in the email address 111n; “TEL of C” is set in the telephone number 111o; “0” is set in the possessor flag 111p (indicating that the ticket is not possessed); and “0” is set in the QR acquisition count 111l (see No4 in FIG. 10).

Then, the ticket allotting unit 121 sends a QR acquisition email to the email address of the user to whom the seat b is to be transferred (i.e., the user C to whom the seat b is to be allotted) (Step S52). At the same time, the ticket allotting unit 121 sends a QR returning email to the user B who is the current possessor of the seat b (Step S53).

When the user B accesses a QR returning URL, the QR returning unit 122 displays a QR returning approval screen (Step S54). Then, from the QR returning approval screen, the user B issues a QR returning approval corresponding to the seat b. In response, in the record of the user B, the QR returning unit 122 sets the possessor flag 111p to “9” (indicating release of the ticket from possession). At the same time, in the record of the user C, the QR returning unit 122 sets the possessor flag 111p to “1” (indicating that the ticket can be possessed) (see No5 in FIG. 10). With that, the QR returning unit 122 invalidates the QR code corresponding to the user B, but validates the QR code corresponding to the user C. As a result, the user B is no more the possessor of the seat b.

Subsequently, when the user C accesses the QR acquisition URL, the QR displaying unit 123 displays the QR acquisition screen (Step S55). Then, from the QR acquisition screen, the user C inputs the telephone number and the password thereof. If the telephone number and the password that are input match with the telephone number 111o and the password B 111m, respectively, corresponding to the user C in the management DB 111; the QR displaying unit 123 determines that the user C is legitimate. Moreover, if the possessor flag 111p corresponding to the user C is set to “1” (indicating that the ticket can be possessed), then the QR displaying unit 123 sets “1” in the QR acquisition count 111l in the record of the user C (see No6 in FIG. 10). Then, the QR displaying unit 123 displays a QR code to the user C.

As a result, the possessor of the seat b is changed from the user B to the user C.

Sequence of Operations Performed During Ticket Transfer Managing Operation in Case of No QR Returning Approval by User from Whom Ticket is to be Transferred

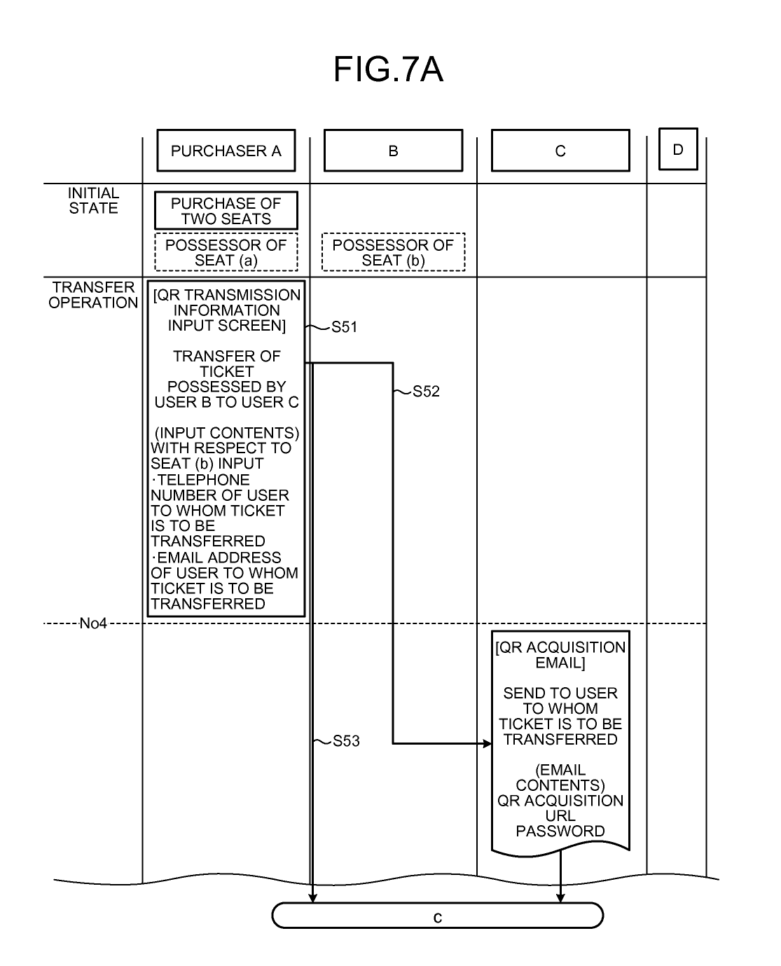

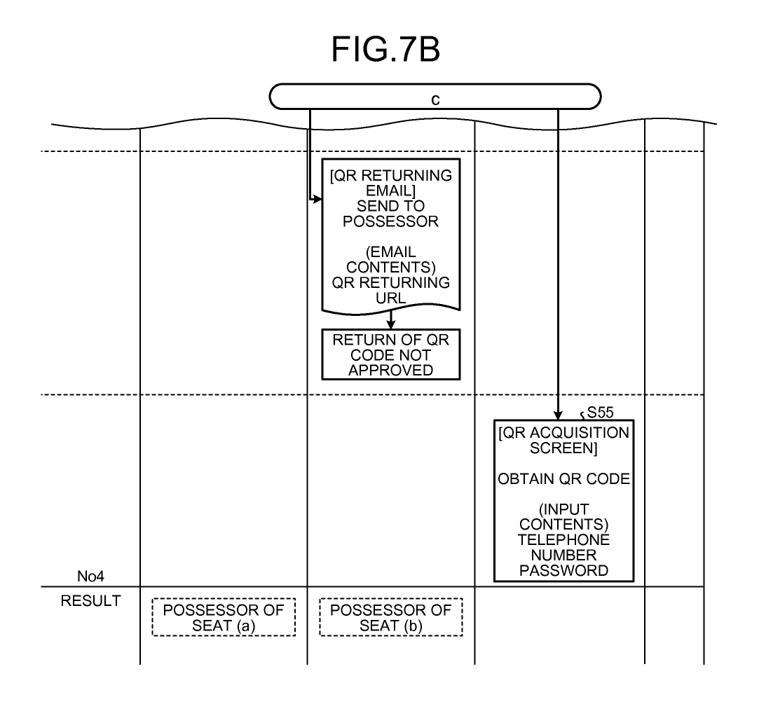

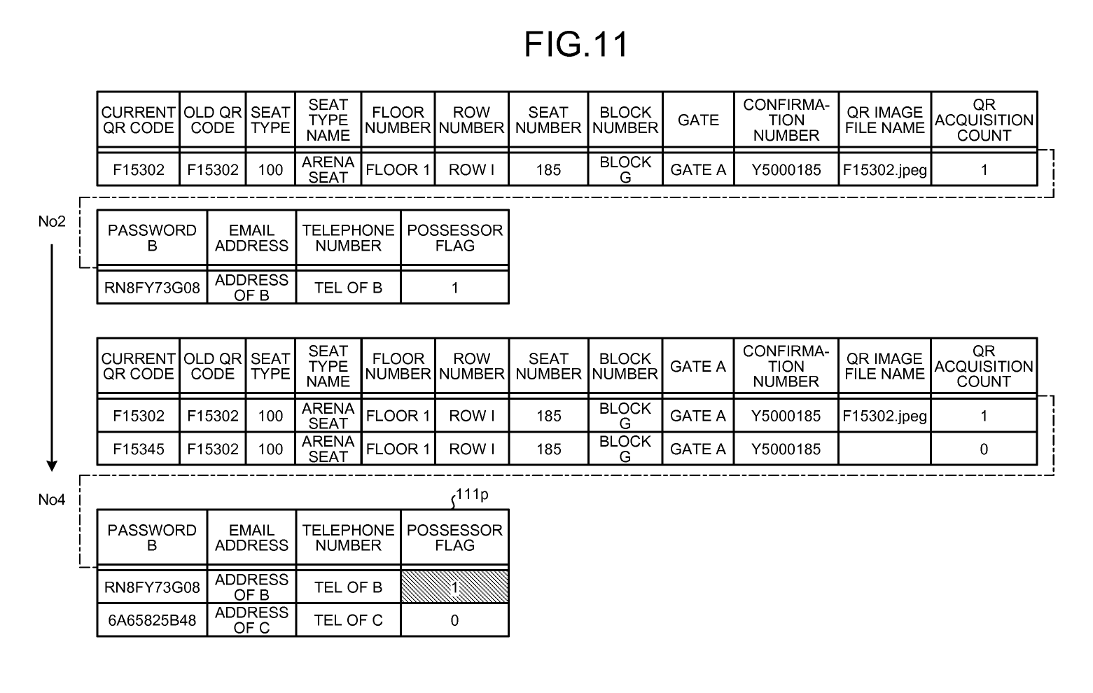

Explained below with reference to FIG. 7 is a sequence of operations performed during the ticket transfer managing operation in the case when the user B, from whom the seat b is to be transferred, does not send a QR returning approval in response to receiving the QR returning email. FIGS. 7A and 7B are a sequence diagram for explaining a sequence of operations performed during the ticket transfer managing operation in the case of no QR returning approval by the user from whom the ticket is to be transferred. Herein, the operations identical to the operations performed during the ticket transfer managing operation in the case of a normal transfer illustrated in FIG. 6 are referred to by the same step numbers, and the explanation thereof is not repeated. Meanwhile, the following explanation is given with reference to the record of the seat b maintained in the management DB 111 as illustrated in FIG. 11.

The ticket allotting unit 121 sends a QR acquisition email to the email address of the user to whom the seat b is to be transferred (i.e., the user C to whom the seat b is to be allotted) (Step S52). At the same time, the ticket allotting unit 121 sends a QR returning email to the user B who is the current possessor of the seat b (Step S53). However, it is assumed that the user B does not access the QR returning URL and does not send a QR returning approval.

Subsequently, when the user C accesses the QR acquisition URL, the QR displaying unit 123 displays the QR acquisition screen (Step S55). Then, from the QR acquisition screen, the user C inputs the telephone number and the password thereof. If the telephone number and the password that are input match with the telephone number 111o and the password B 111m, respectively, corresponding to the user C in the management DB 111; the QR displaying unit 123 determines that the user C is legitimate.

However, since the possessor flag 111p corresponding to the user B is set to “1” (indicating that the ticket can be possessed) and not set to “9” (not indicating release of the ticket from possession) (see No4 in FIG. 11), the QR displaying unit 123 displays an acquisition error. That is, since there is no QR returning approval from the user B who is the current possessor of the seat b, the user C to whom the seat b is to be transferred does not obtain the QR code.

As a result, the user B remains the possessor of the seat b, and the user C does not become the possessor.

Sequence of Operations Performed During Ticket Transfer Managing Operation when User to Whom Ticket is to be Transferred does not Obtain QR Code

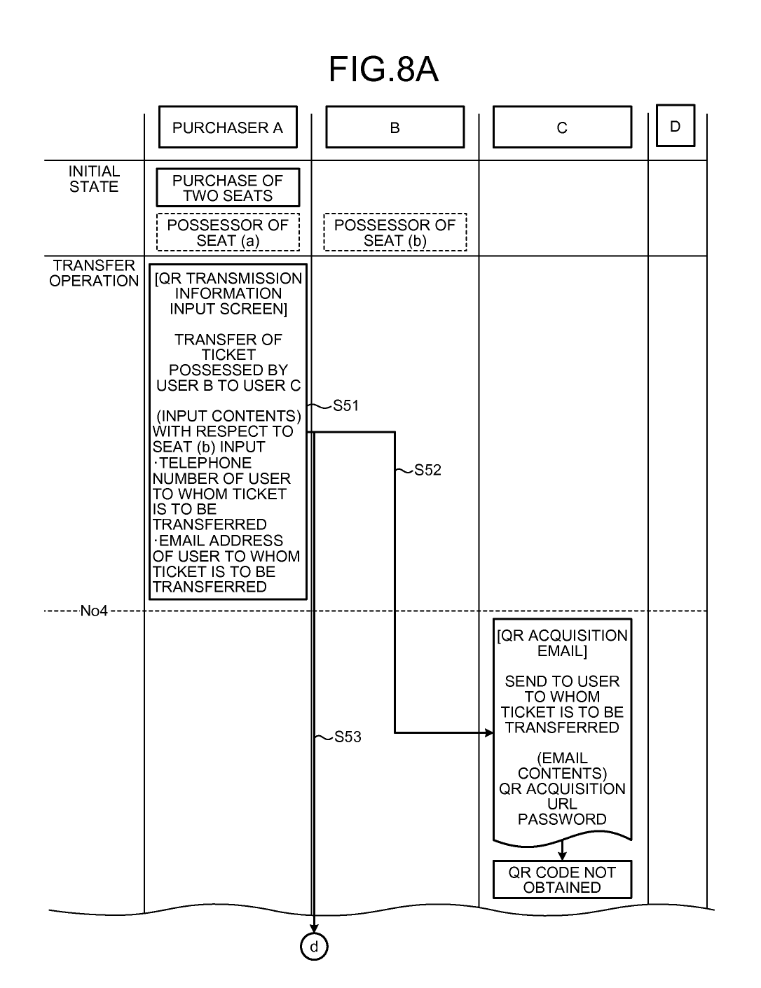

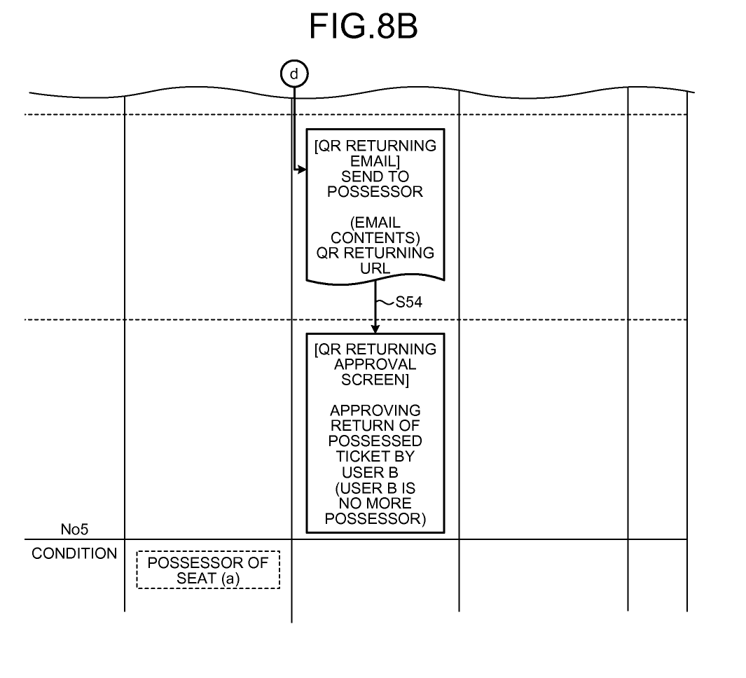

Explained below with reference to FIG. 8 is a sequence of operations performed during the ticket transfer managing operation in the case when the user C, to whom the seat b is to be transferred, does not obtain the QR code even after the user B, from whom the seat b is to be transferred, has sent a QR returning approval. FIGS. 8A and 8B are a sequence diagram for explaining a sequence of operations performed during the ticket transfer managing operation in the case when the user to whom the ticket is to be transferred does not obtain the QR code. Herein, the operations identical to the operations performed during the ticket transfer managing operation in the case of a normal transfer illustrated in FIG. 6 are referred to by the same step numbers, and the explanation thereof is not repeated. Meanwhile, the following explanation is given with reference to the record of the seat b maintained in the management DB 111 as illustrated in FIG. 10.

The ticket allotting unit 121 sends a QR acquisition email to the email address of the user to whom the seat b is to be transferred (i.e., the user C to whom the seat b is to be allotted) (Step S52). At the same time, the ticket allotting unit 121 sends a QR returning email to the user B who is the current possessor of the seat b (Step S53).

When the user B accesses the QR returning URL, the QR returning unit 122 displays the QR returning approval screen (Step S54). Then, from the QR returning approval screen, the user B issues a QR returning approval corresponding to the seat b. In response, in the record of the user B, the QR returning unit 122 sets the possessor flag 111p to “9” (indicating release of the ticket from possession). At the same time, in the record of the user C, the QR returning unit 122 sets the possessor flag 111p to “1” (indicating that the ticket can be possessed) (see No5 in FIG. 10). With that, the QR returning unit 122 invalidates the QR code corresponding to the user B, but validates the QR code corresponding to the user C. As a result, the user B is no more the possessor of the seat b.

However, herein it is assumed that the user C to whom the seat b is to be transferred does not access the QR acquisition URL and does not obtain the QR code. Hence, the seat b happens to have no possessor. In that regard, explained below is a case in which the right to the seat b is transferred from the user C, who has not obtained the corresponding QR code, to a different user.

Sequence of Operations Performed During Ticket Transfer Managing Operation for Transferring Right of User Who has not Obtained QR Code

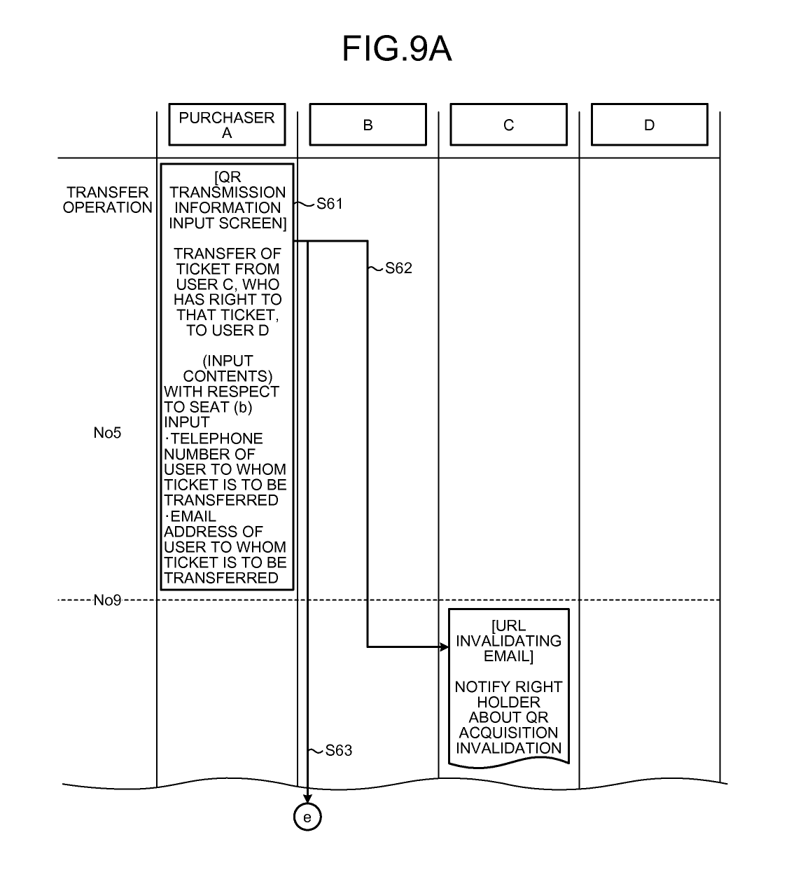

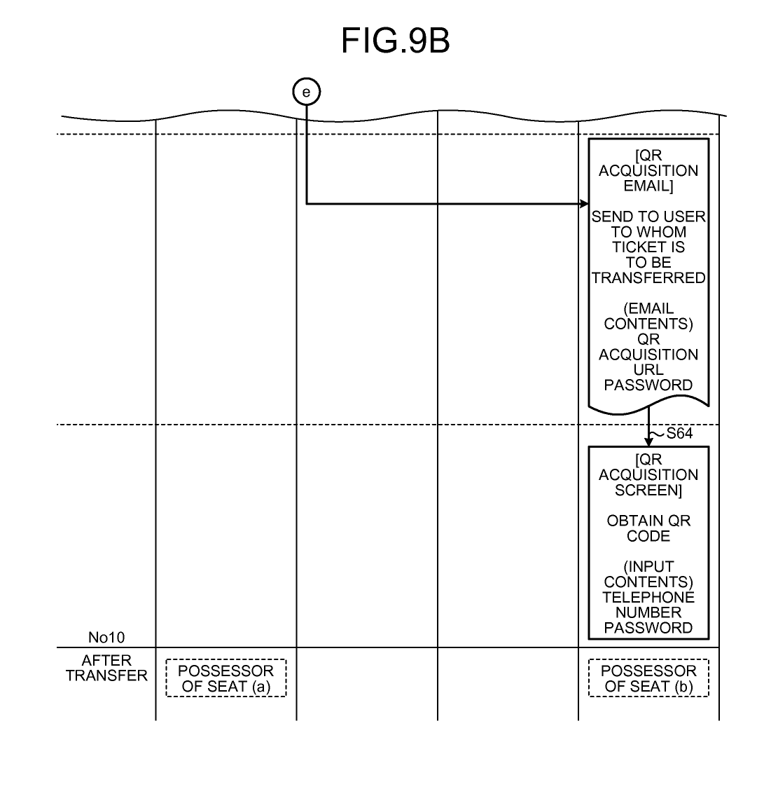

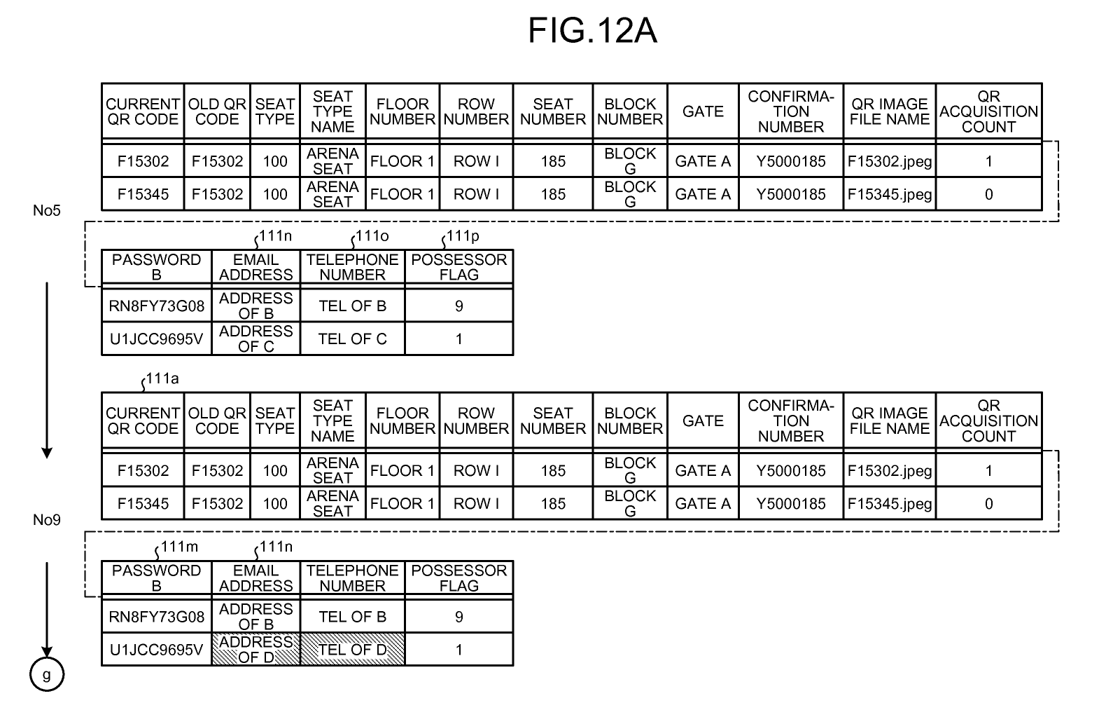

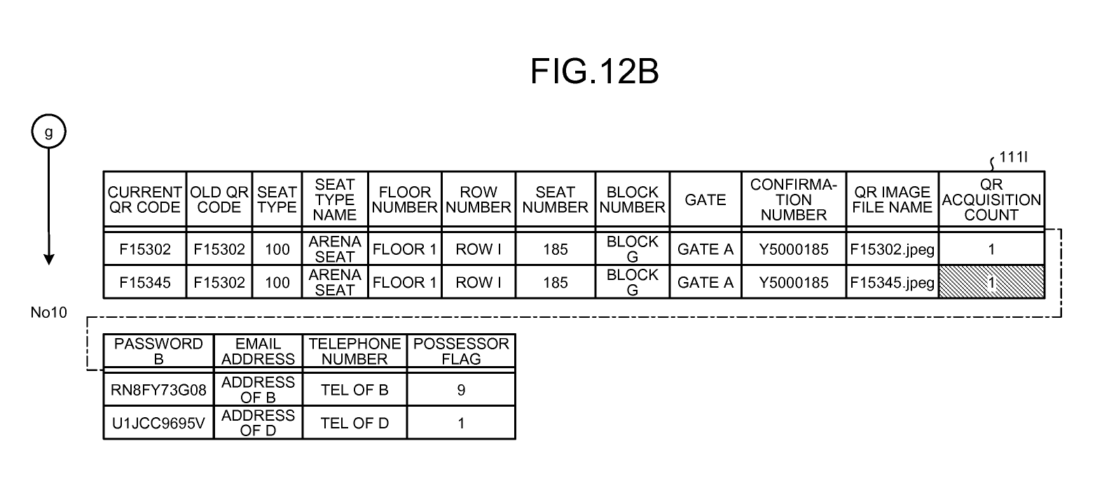

FIGS. 9A and 9B are a sequence diagram for explaining a sequence of operations performed during the ticket transfer managing operation in the case of transferring the right of the user who has not obtained the QR code. Meanwhile, the following explanation is given with reference to the record of the seat b maintained in the management DB 111 as illustrated in FIG. 12.

When the authentication of the purchaser A is successful, the ticket allotting unit 121 displays the QR transmission information input screen (Step S61).

At that point of time, in the record of the seat b maintained corresponding to the user B in the management DB 111, “address of B” is set in the email address 111n; “TEL of B” is set in the telephone number 111o; and “9” is set in the possessor flag 111p (indicating release of the ticket from possession). Similarly, in the record of the seat b maintained corresponding to the user C in the management DB 111, “address of C” is set in the email address 111n; “TEL of C” is set in the telephone number 111o; “1” is set in the possessor flag 111p (indicating that the ticket can be possessed); and “0” is set in the QR acquisition count 111l (see No5 in FIG. 12).

From the QR transmission information input screen; the purchaser A inputs the telephone number and the email address of the user to whom the seat b is to be transferred (i.e., a user D to whom the seat b is to be allotted). Then, regarding the user from whom the seat b is to be transferred (i.e., the user C), since the possessor flag 111p is “1” and the QR acquisition count 111l is “0”; the ticket allotting unit 121 determines that the user C has not obtained the QR code. Hence, the ticket allotting unit 121 sends a URL invalidation email to the right holder of the un-obtained QR code (i.e., to the user C) (Step S62). With that, the ticket allotting unit 121 invalidates the un-obtained QR code of the right holder of the seat b (i.e., the un-obtained QR code of the user C).

Then, the ticket allotting unit 121 sends a QR acquisition email to the email address of the user to whom the seat b is to be transferred (i.e., the user D to whom the seat b is to be allotted) (Step S63). Subsequently, the ticket allotting unit 121 overwrites the record of the right holder of the un-obtained QR code (i.e., the record of the user C) with the user information of the user D to whom the seat b is to be newly allotted.

Thus, with respect to the seat b in the management DB 111, “address of D” is set in the email address 111n and “TEL of D” is set in the telephone number 111o (see No9 in FIG. 12).

When the user D accesses the QR acquisition URL, the QR displaying unit 123 displays the QR acquisition screen (Step S64). Then, from the QR acquisition screen, the user D inputs the telephone number and the password thereof. If the telephone number and the password that are input match with the telephone number 111o and the password B 111m, respectively, corresponding to the user D in the management DB 111; the QR displaying unit 123 determines that the user D is legitimate. Moreover, since the possessor flag 111p corresponding to the user D is set to “1” (indicating that the ticket can be possessed), the QR displaying unit 123 sets “1” in the QR acquisition count 111l in the record of the user D (see No10 in FIG. 12). Then, the QR displaying unit 123 displays a QR code to the user D.

As a result, the possessor of the seat b is changed from the user B to the user D.

Transition of Screens During Ticket Transfer Management

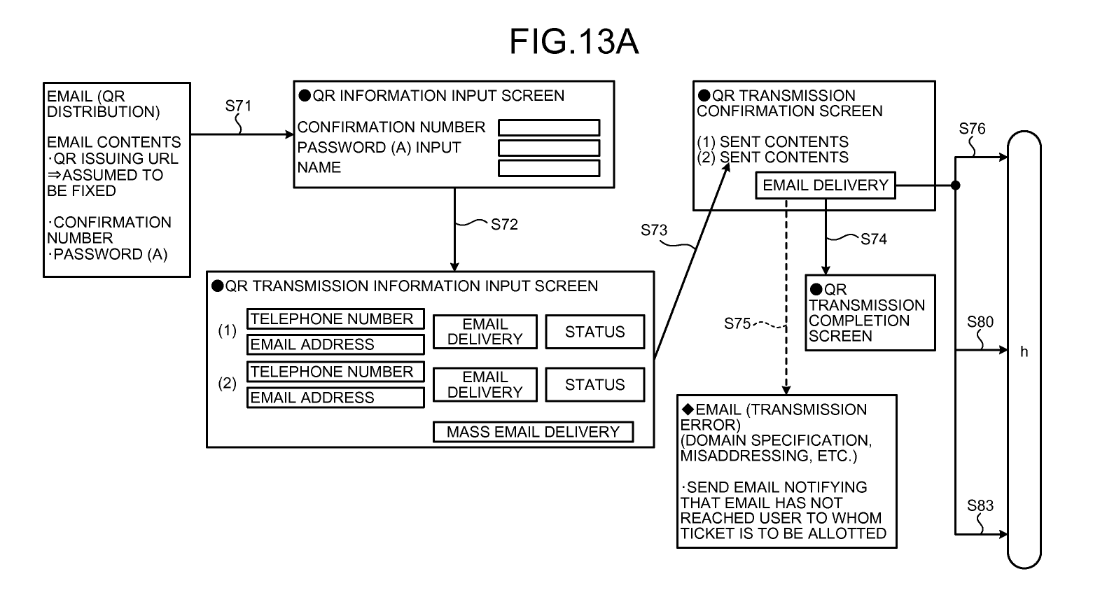

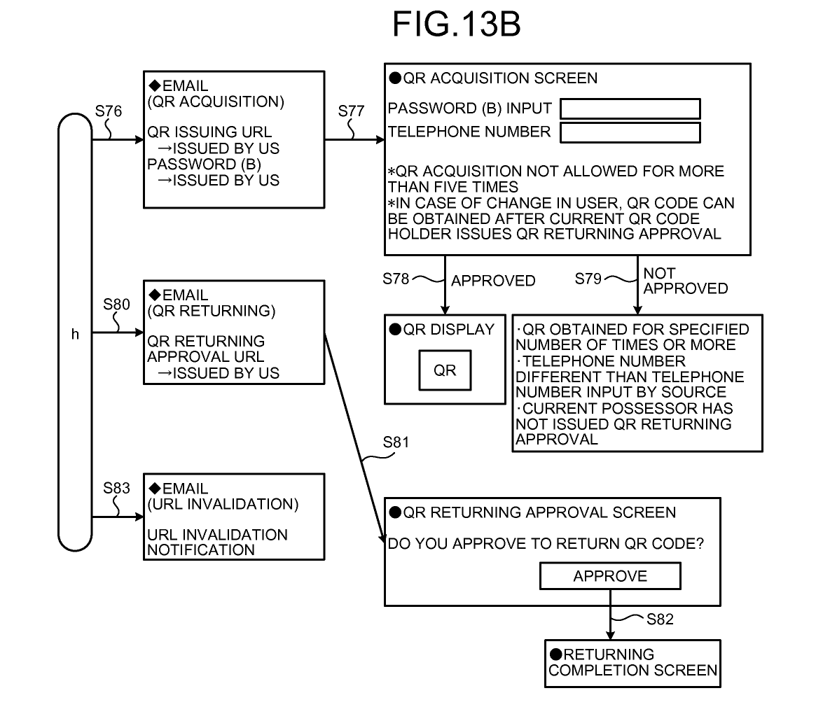

Explained below with reference to FIG. 13 is the transition of screens that occurs during the ticket transfer management according to the first embodiment. FIGS. 13A and 13B are a diagram for explaining the transition of screens that occurs during the ticket transfer management according to the first embodiment.

As illustrated in FIGS. 13A and 13B, when a purchaser purchases tickets, the ticket selling website 3 sends a QR distribution email to the handheld device 2 of the purchaser. When the QR issuing URL specified in the QR distribution email is accessed, the ticket allotting unit 121 displays a QR information input screen (Step S71).

When the purchaser inputs the confirmation number, the password A, and the name from the QR information input screen; the ticket allotting unit 121 displays the QR transmission information input screen only if the authentication of the purchaser is successful (Step S72). Subsequently, for each ticket (i.e., for each set of seat information), when the purchaser inputs from the QR transmission information input screen the telephone number and the email address of the user to whom that ticket is to be allotted; the ticket allotting unit 121 displays a QR transmission confirmation screen that prompts confirmation of the details regarding the users to whom the tickets are to be allotted (Step S73).

On the QR transmission confirmation screen, when the purchaser presses an email delivery button; the ticket allotting unit 121 displays a QR transmission completion screen only if there is no mistake in the sent details regarding the users to whom the tickets are to be allotted (Step S74). On the other hand, if there is any mistake in the sent details regarding the users to whom the tickets are to be allotted, the ticket allotting unit 121 sends a transmission error email to the handheld device 2 of the purchaser (Step S75).

Moreover, when the purchaser presses an email delivery button on the QR transmission confirmation screen; if there is no mistake in the sent details regarding the users to whom the tickets are to be allotted, the ticket allotting unit 121 sends a QR acquisition email to the handheld device 2 of each user to whom a ticket is to be allotted (Step S76). When that user accesses the QR acquisition URL specified in the QR acquisition email, the QR displaying unit 123 displays the QR acquisition screen (Step S77).

When the user to whom a ticket is to be allotted inputs the password B and the telephone number from the QR acquisition screen; the QR displaying unit 123 displays the QR code only if the authentication is successful (Step S78). On the other hand, if the authentication is not successful or if an acquisition condition is not satisfied, then the QR displaying unit displays a QR acquisition error (Step S79). Herein, not satisfying the acquisition condition points to, for example, a case in which the QR code acquisition count becomes equal to or exceeds the specified count, or a case in which the current possessor of the QR code has not done the QR returning approval.

In the case of transferring a ticket (a set of seat information) to a new user from the QR transmission confirmation screen; if the user who allots the seat information has obtained the QR code, then the ticket allotting unit 121 sends a QR returning email to the handheld device 2 of the user who allots the seat information (Step S80). When that user accesses a QR returning approval URL specified in the QR returning email, the QR returning unit 122 displays the QR returning approval screen (Step S81).

When that user presses an approve button on the QR returning approval screen, the QR returning unit 122 displays a returning completion screen (Step S82). As a result, the QR code that has been returned is invalidated.

On the other hand, in the case of transferring a ticket (a set of seat information) to a new user from the QR transmission confirmation screen; if the user who allots the seat information has not obtained the QR code, then the ticket allotting unit 121 sends a URL invalidation email to the handheld device 2 of that user (Step S83). With that, the QR acquisition URL of the user who allots the seat information is invalidated.

Example of Screens and Emails Used in Ticket Transfer Managing Operation

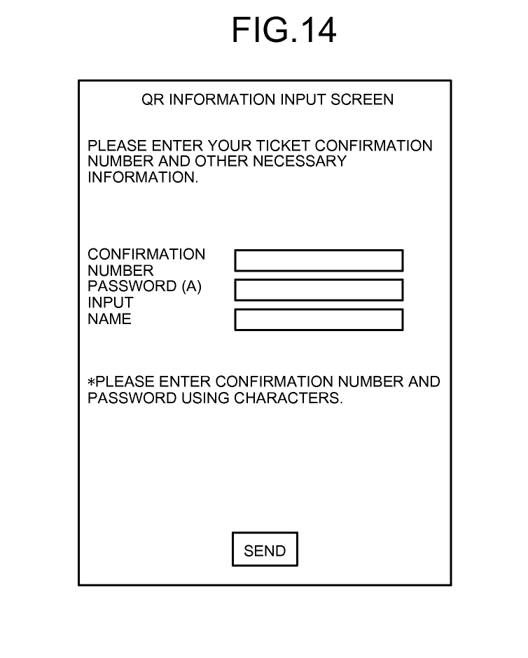

FIG. 14 is a diagram illustrating an example of the QR information input screen. As illustrated in FIG. 14, when a ticket purchaser accesses the QR issuing URL from the handheld device 2, the ticket allotting unit 121 displays text boxes that enable input of the confirmation number, the password, and the name. Moreover, the ticket allotting unit 121 displays a send button to enable transition to the QR transmission information input screen. With reference to FIG. 14, if authentication of the purchaser performed by the ticket allotting unit 121 is successful, transition to the QR transmission information input screen is possible.

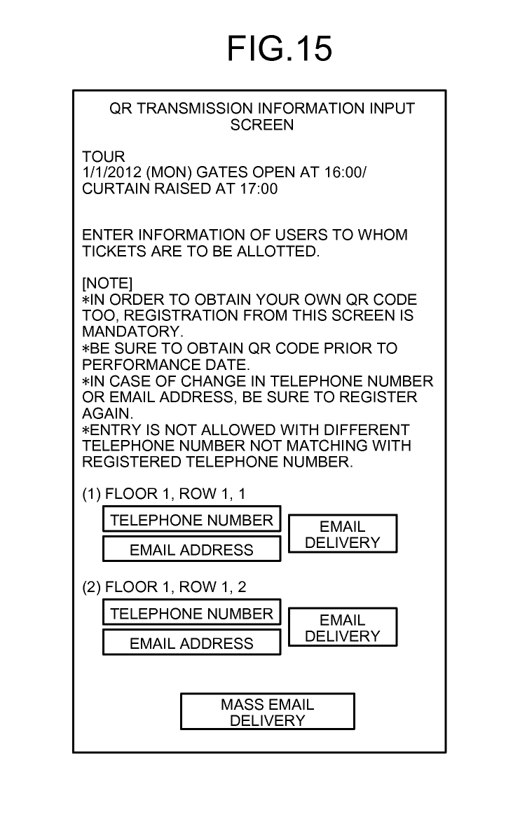

FIG. 15 is a diagram illustrating an example of the QR transmission information input screen. As illustrated in FIG. 15, the ticket allotting unit 121 displays, for each set of seat information, text boxes that enable input of the telephone number and the email address of the user to whom the corresponding ticket is to be allotted. Moreover, in order to send, via the QR transmission information input screen, a QR acquisition email to each user to whom a ticket is to be allotted; the ticket allotting unit 121 displays an email delivery button for each set of seat information. Moreover, in order to send QR acquisition emails in a collective manner to all users to whom tickets are to be allotted according to the input seat information, the ticket allotting unit 121 displays a mass email delivery button. With reference to FIG. 15, the ticket allotting unit 121 can make the purchaser input, for each set of seat information, the user to whom the corresponding ticket is to be allotted. Meanwhile, the QR transmission information input screen is also used in the case of changing the user to whom a ticket is to be allotted. An example of the QR transmission information input screen for that case is given later.

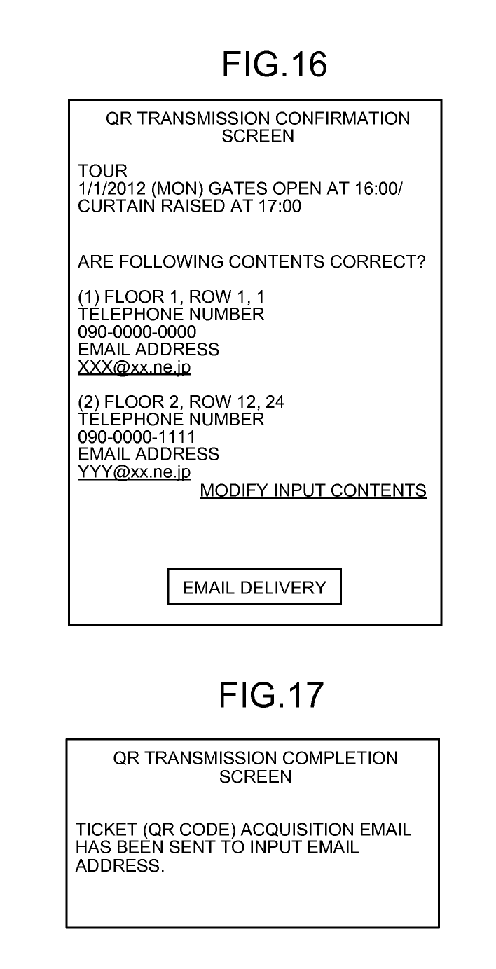

FIG. 16 is a diagram illustrating an example of the QR transmission confirmation screen. As illustrated in FIG. 16, the ticket allotting unit 121 displays the allotment destination information that is input for each set of seat information from the QR transmission information input screen. Moreover, the ticket allotting unit 121 displays an email delivery button to enable sending QR acquisition emails to the users to whom the tickets are to be allotted. With reference to FIG. 16, the ticket allotting unit 121 can make the purchaser confirm each user to whom a ticket corresponding to a set of seat information is to be allotted.

FIG. 17 is a diagram illustrating an example of the QR transmission completion screen. As illustrated in FIG. 17, the ticket allotting unit 121 displays a message notifying that the QR acquisition email has been sent to each user to whom a ticket is to be allotted. With reference to FIG. 17, the ticket allotting unit 121 can make the purchaser confirm that the QR acquisition email has been sent to each user to whom a ticket is to be allotted.

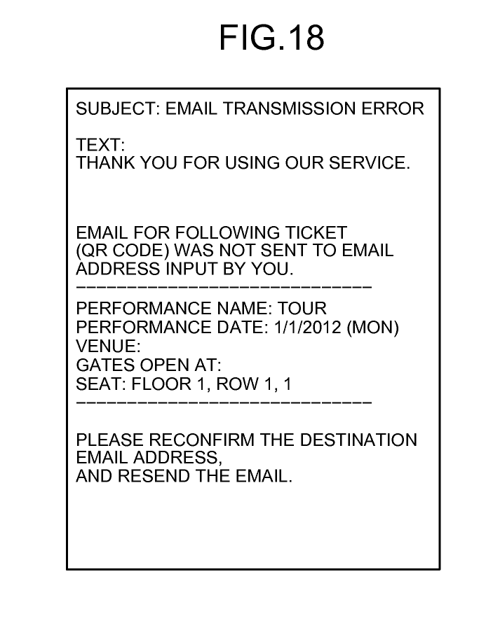

FIG. 18 is a diagram illustrating an example of the transmission error email. As illustrated in FIG. 18, the ticket allotting unit 121 displays a message notifying that the QR acquisition email was not successfully sent to a user to whom a ticket is to be allotted. With reference to FIG. 18, the ticket allotting unit 121 can notify the purchaser that the QR acquisition email was not successfully sent to a user to whom a ticket is to be allotted.

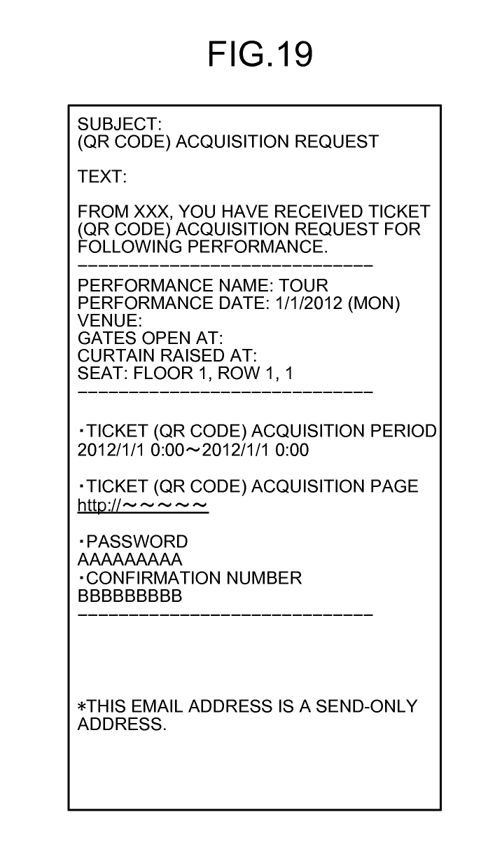

FIG. 19 is a diagram illustrating an example of the QR acquisition email. As illustrated in FIG. 19, the QR acquisition email contains the seat information of an allotted ticket; and the confirmation number as well as the password and the QR acquisition URL used for obtaining the QR code. With reference to FIG. 19, the QR acquisition email can prompt the user to whom the ticket is allotted to obtain the QR code. Meanwhile, the QR acquisition email is sent from the ticket allotting unit 121 to the handheld device 2 of the user to whom the ticket is allotted.

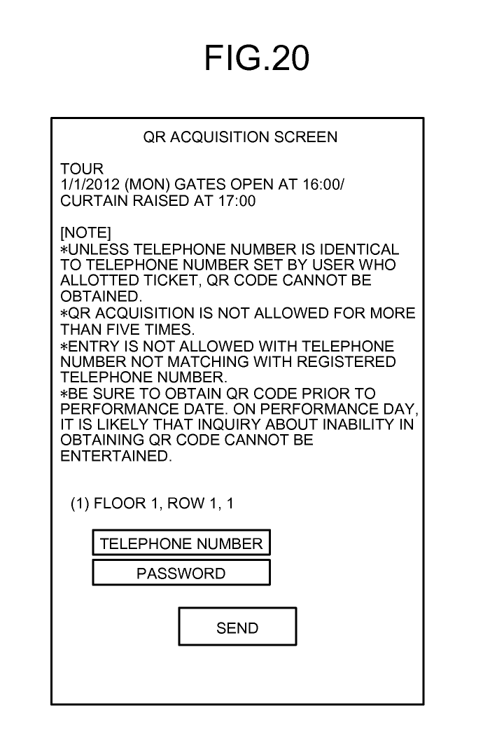

FIG. 20 is a diagram illustrating an example of the QR acquisition screen. As illustrated in FIG. 20, the QR displaying unit 123 displays not only the seat information of an allotted ticket but also text boxes that enable input of the telephone number and the password. Moreover, the QR displaying unit 123 displays a send button so as to display the QR code after authenticating the user to whom the ticket is allotted. With reference to FIG. 20, the QR displaying unit 123 can display the QR code only if the authentication is successful and if the acquisition condition is satisfied.

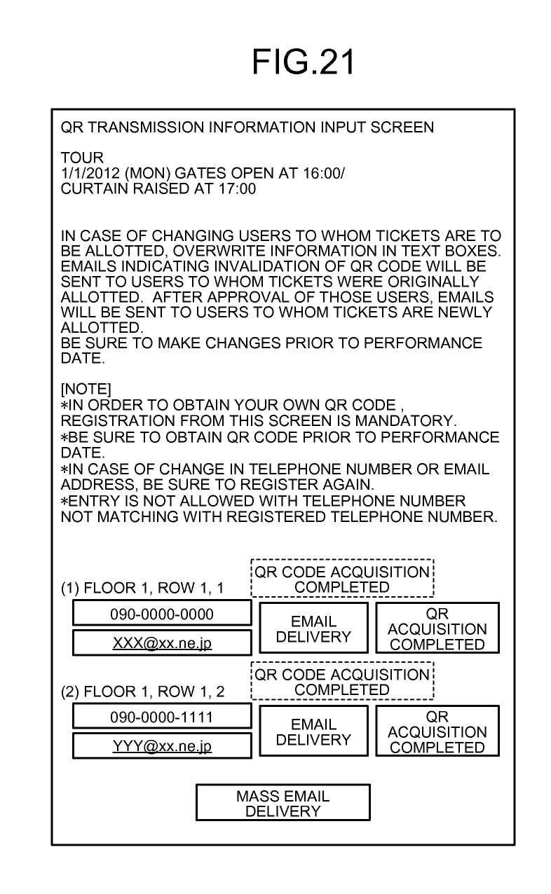

FIG. 21 is a diagram illustrating an example of the QR transmission information input screen in the case of changing the users to whom the tickets are to be allotted. As illustrated in FIG. 21, the ticket allotting unit 121 displays text boxes that enable input of the telephone number and the email address of each new user to whom the ticket corresponding to a set of seat information is to be allotted. In each text box for inputting a telephone number is displayed the telephone number of the user to whom the corresponding ticket is already allotted. Similarly, in each text box for inputting an email address is displayed the email address of the user to whom the corresponding ticket is already allotted. Moreover, for each user to whom a ticket is already allotted, the ticket allotting unit 121 displays a status regarding QR code acquisition. For example, in the status, either “QR acquisition awaited” is displayed indicating that the acquisition of the QR code is awaited; or “QR acquisition completed” is displayed indicating that the QR code has been obtained. For a user to whom a ticket is to be allotted, if the possessor flag 111p is set to “1” (indicating that the ticket can be possessed) and the QR acquisition count 111l is set to “0” in the management DB 111; then the ticket allotting unit 121 can display “QR acquisition awaited” in the corresponding status. In contrast, for a user to whom a ticket is to be allotted, if the possessor flag 111p is set to “1” (indicating that the ticket can be possessed) and the QR acquisition count 111l is set to “1 or more” in the management DB 111; then the ticket allotting unit 121 can display “QR acquisition completed” in the corresponding status. With reference to FIG. 21, the ticket allotting unit 121 can make the purchaser change the users to whom the tickets are to be allotted as well as can make the purchaser confirm the QR code acquisition status of the users to whom the tickets are allotted.

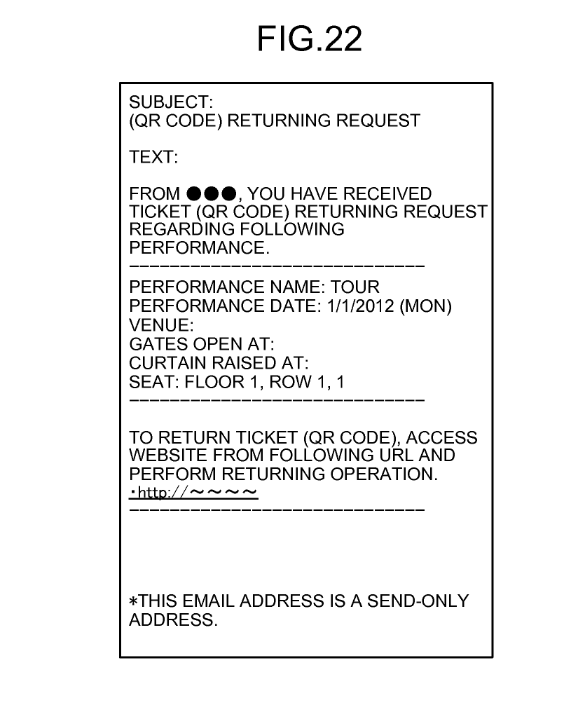

FIG. 22 is a diagram illustrating an example of the QR returning email. As illustrated in FIG. 22, the QR returning email contains the seat information of a ticket that was allotted, a message notifying to return the QR code, and the QR returning approval URL. With reference to FIG. 22, the QR returning email can prompt the user to whom the ticket was allotted to approve returning of the corresponding QR code. Meanwhile, the QR returning email is sent by the QR returning unit 122 to the handheld device 2 of the user to whom the corresponding ticket was allotted.

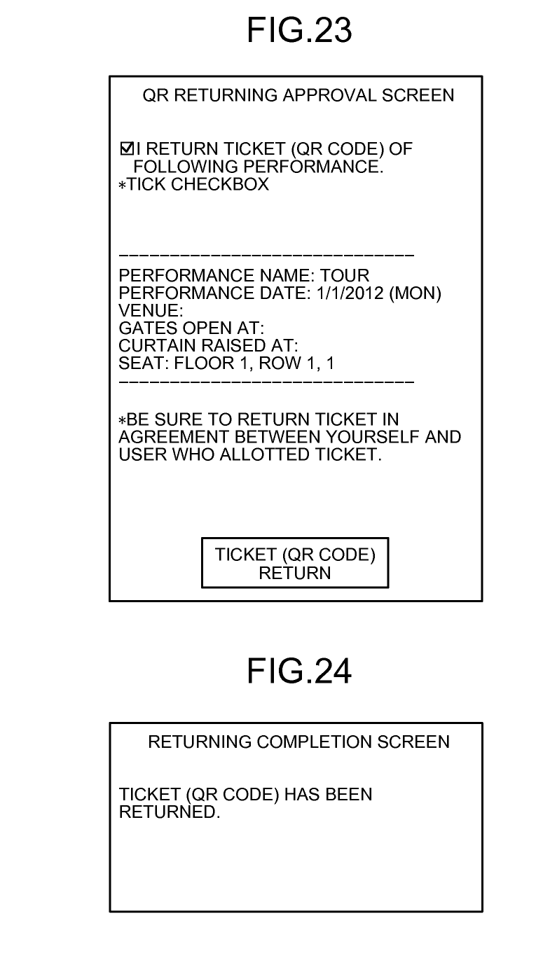

FIG. 23 is a diagram illustrating an example of the QR returning approval screen. As illustrated in FIG. 23, the QR returning unit 122 displays a checkbox that can be checked in the case of approving the return of the QR code. Moreover, the QR returning unit 122 displays a ticket (QR code) return button to enable returning of the QR code. With reference to FIG. 23, the QR returning unit 122 can first make the possessor of a ticket approve returning of the corresponding QR code and then make the possessor return that QR code.

FIG. 24 is a diagram illustrating an example of the returning completion screen. As illustrated in FIG. 24; the QR returning unit 122 displays a message notifying that the QR code has been returned. With reference to FIG. 24; the QR returning unit 122 can make the possessor, who has returned the QR code, confirm that the QR code has been returned.

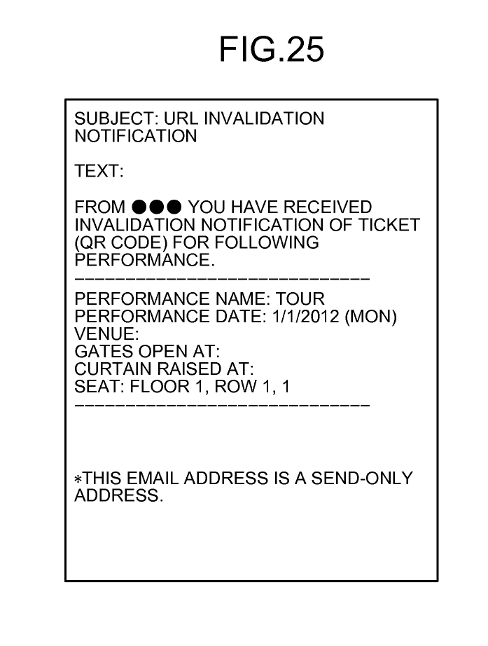

FIG. 25 is a diagram illustrating an example of a QR acquisition URL invalidation email. As illustrated in FIG. 25, the QR acquisition URL invalidation email (the URL invalidation email) contains a message notifying that the allotted ticket has been invalidated. With reference to FIG. 25, the QR acquisition URL invalidation email can make the user to whom the ticket was allotted confirm that the allotted ticket is invalidated. Meanwhile, the QR acquisition URL invalidation email is sent by the ticket allotting unit 121 to the handheld device 2 of the user to whom the ticket was allotted.

The QR authenticating unit 124 receives a QR code that is read by a reading device at the time of entry; cross-checks the received QR code against QR images linked inside the management DB 111; and, if the received QR code matches with a QR image, sends a notification to the reading device about the permission of entry. On the other hand, if the received QR code does not match with any QR image, then the QR authenticating unit 124 sends a notification to the reading device about disallowing the entry. However, that is not the only possible case. Alternatively, if the received QR code matches with a QR image, then the QR authenticating unit 124 can determine whether or not the received QR code has been validated and can send the determination result to the reading device. For example, the QR authenticating unit 124 refers to the possessor flag 111p stored corresponding to the received QR code in the management DB 111 and determines whether or not the received QR code has been validated. That is, if the processor flag 111p is set to “1” (indicating that the ticket can be possessed), then the QR authenticating unit 124 determines that the QR code is valid. On the other hand, if the processor flag 111p is set to “9” (indicating release of the ticket from possession), then the QR authenticating unit 124 determines that the QR code is invalid. Subsequently, to the reading device, the QR authenticating unit 124 sends the determination result of whether the received QR code is valid or invalid. With that, the QR authenticating unit 124 can make the reading device identify not only the QR codes that did not match with a QR image but also the QR codes that are invalidated. Thus, the reading device can disallow entry of not only the users corresponding to the QR codes that did not match with a QR image but also the users corresponding to the QR codes that are invalidated.

Meanwhile, if the received QR code matches with a QR image, the QR authenticating unit 124 can determine whether or not the received QR code has been validated. Then, if the QR code is determined to have been validated, the QR authenticating unit 124 can further send an email about the permission of entry to the handheld device 2 of the user stored in the management DB 111. With that, at the time of entry of the users, since the QR authenticating unit 124 sends an email to only the authentic users corresponding to valid QR codes, the legitimacy check of users that is likely to be done after the entry can be performed in a smooth manner.

Meanwhile, if a particular QR code is received more than once, then the QR authenticating unit 124 can notify the reading device about the multiple accesses. In this regard, the QR authenticating unit 124 can hold the access count for each QR code in the memory unit 11; and when a QR code is accessed, can refer to the access count for that QR code. With that, the QR authenticating unit 124 can make the reading device identify a QR code corresponding to the user having multiple entries. That is, the reading device becomes able to identify a duplicated QR code. Moreover, at the time of notifying the reading device about multiple accesses, the QR authenticating unit 124 can also send the telephone number of the corresponding user stored in the management DB 111. As a result, the reading device can identify the telephone number of the user corresponding to the QR code that has been accessed more than once, and thus can check the telephone numbers of the users at the time of entry.

Modification Example of Ticket Transfer Managing Operation

In the first embodiment, in the case when a ticket that is already allotted to a particular user is to be transferred to another user; only after the QR code of the already-allotted ticket is returned, the server 10 allows the user to whom the ticket is to be transferred obtain the corresponding QR code. That is, only after the QR code of the user from whom the ticket is to be transferred is invalidated and after the QR code of the user to whom the ticket is to be transferred is validated, the server 10 displays the QR code of the to-be-transferred ticket on the handheld device 2 of the user to whom the ticket is to be transferred. However, that is not the only possible case. Alternatively, in the case when a ticket that is already allotted to a particular user is to be transferred to another user; even if the QR code of the already-allotted ticket is not returned, the server 10 can allow the user to whom the ticket is to be transferred obtain the corresponding QR code. For example, without determining whether the QR code of the user from whom the ticket is to be transferred is invalidated and whether the QR code of the user to whom the ticket is to be transferred is validated, the QR displaying unit 123 displays the QR code of the to-be-transferred ticket on the handheld device 2 of the user to whom the ticket is to be transferred. As a result, regardless of invalidation or validation of QR codes, the user to whom the ticket is transferred can indicate the QR code given thereto. However, in an identical manner to the first embodiment, the user to whom the ticket is to be transferred is allowed to enter only after validation of the corresponding QR code. That is, the user to whom the ticket is to be transferred is allowed to enter only after the server 10 invalidates the QR code returned by the user from whom the ticket is transferred and validates the QR code of the user to whom the ticket is transferred.

### Effect of First Embodiment

According to the first embodiment, in response to a request issued by a purchaser (first user), the server 10 generates first-type image code to be used for authentication purpose and then stores the first-type image code in the management DB 111 in a corresponding manner to the user to whom a ticket is to be allotted (second user). Then, in response to a request issued by the purchaser (first user), in the case of transferring a ticket from the user to whom that ticket was allotted, the server 10 generates second-type image code that is different from the first-type image code and then stores the second-type image code in the management DB 111 in a corresponding manner to a new user to whom the transferred-ticket is to be allotted (third user). Subsequently, the server 10 invalidates the first-type image code stored in the management DB 111 and validates the second-type image code stored in the management DB 111. Then, the server 10 sends the second-type image code to the address of the third user. Since the server 10 invalidates the image code corresponding to the user to whom a ticket was originally allotted and validates the image code corresponding to the user to whom the ticket is newly allotted, the purchaser of the ticket can uniquely manage the transfer of the ticket corresponding to the image code.

Moreover, according to the first embodiment, when the first-type image code is invalidated and when the second-type image code is validated, the server 10 sends the second-type image code to the address of the third user. Hence, unless and until the first-type image code is invalidated and the second-type image code is validated, it can be ensured that the third user is not allowed to possess the second-type image code. As a result, it becomes possible to manage the transfer of the ticket corresponding to the image code in a strict manner.

Furthermore, according to the first embodiment, the server 10 does not determine whether the first-type image code is invalidated and whether the second-type image code is validated, and sends the second-type image code to the address of the third user. Hence, regardless of whether the first-type image code is invalidated and whether the second-type image code is validated, the third user can possess the second-type image code.

Moreover, according to the first embodiment, if a returning approval for returning the first-type image code is received from the handheld device 2 of the second user, the server 10 invalidates the first-type image code and validates the second-type image code. That is, with returning approval for returning the first-type image code of the second user as the trigger, the server 10 invalidates the first-type image code and validates the second-type image code. Hence, the transfer of the ticket corresponding to the first-type image code and the second-type image code can be managed in a reliable and unique manner.

Furthermore, according to the first embodiment, in the case when the second-type image code has been validated but has not been sent to the handheld device 2 of the third user, the server 10 invalidates the second-type image code without waiting for a returning approval from the third user. With that, the server 10 can safely transfer the ticket corresponding to the second-type image code to a new user.

Moreover, according to the first embodiment, when the second-type image code that is received from a reading device is valid, the server 10 outputs new image code to the handheld device 2 of the user who is linked to the second-type image code stored in the management DB 111. Since the server 10 outputs new image code to the user corresponding to valid image code, it becomes possible to determine the legitimate user at the time of entry. In other words the server 10 can determine, for example, a user who possesses duplicated image code at the time of entry.

Meanwhile, in the first embodiment, the ticket transfer managing system 9 is divided into the ticket transfer managing website 1 and the ticket selling website 3. However, that is not the only possible case. Alternatively, the ticket transfer managing system 9 can have the ticket transfer managing website 1 and the ticket selling website 3 configured in an integrated manner.

Moreover, in the first embodiment, the QR authenticating unit 124 is included in the server 10. However, that is not the only possible case. Alternatively, the QR authenticating unit 124 can be included in a new information processing device that is different from the server 10. In that case, the data stored in the management DB 111 of the server 10 can be copied to the new information processing device.

### [b] Second Embodiment

In the first embodiment, the explanation was given for a case in which, in response to a ticket allotment request issued by a purchaser of tickets, the server 10 transfers the tickets to other users; and, regarding a ticket that has already been transferred, in response to a ticket allotment request issued by the purchaser, the already-transferred ticket is retransferred to a different user. In addition to that, it is also possible to consider the following case. That is, in response to a ticket cancellation request issued by the user to whom a ticket is already transferred to the purchaser of that ticket, the server 10 retransfers (resells) that ticket to a still different user via the ticket supplier (i.e., via the ticket selling website 3). Thus, because of the mediation performed by the ticket supplier, the ticket can be traded without any need of direct communication between the original ticket purchaser and the new ticket purchaser.

In that regard, in a second embodiment, the explanation is given for a case in which, in response to a ticket cancellation request issued by the user to whom a ticket is already transferred to the original purchaser of that ticket, a server retransfers (resells) that ticket to a still different user via a ticket supplier. Herein, in the second embodiment, it is assumed that the ticket supplier points to a ticket selling website.

Configuration of Ticket Transfer Managing System According to Second Embodiment

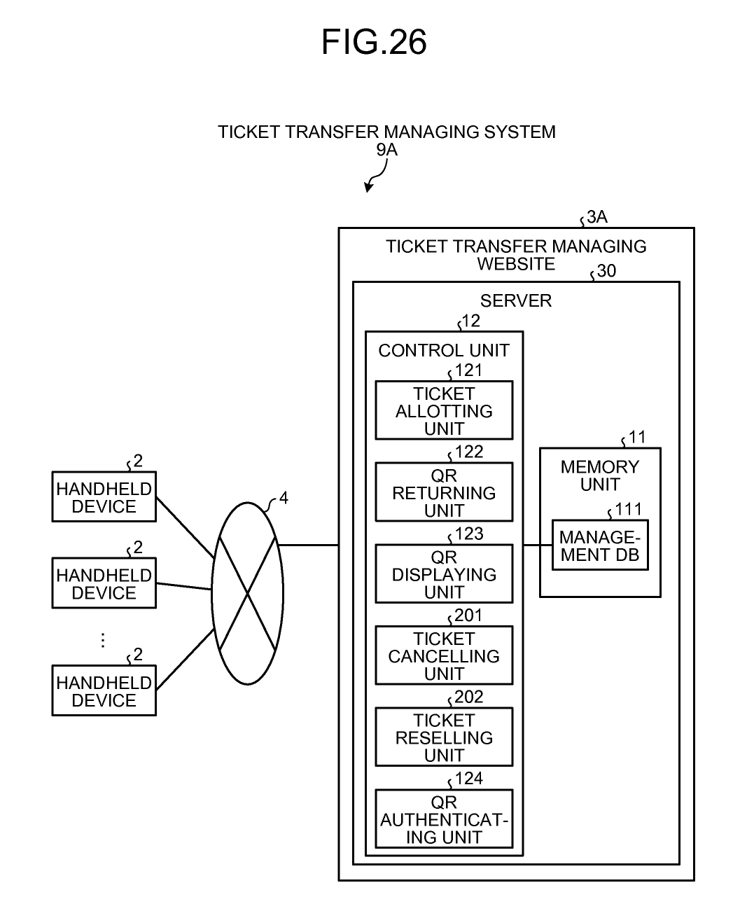

FIG. 26 is a block diagram illustrating an overview of a ticket transfer managing system according to the second embodiment. Herein, the constituent elements identical to the constituent elements of the ticket transfer managing system 9 illustrated in FIG. 1 are referred to by the same reference numerals, and the explanation thereof is not repeated. The second embodiment differs from the first embodiment in the following way. Unlike the ticket transfer managing website 1 according to the first embodiment, a ticket selling website 3A according to the second embodiment includes a server 30 that manages the transfer of tickets. Besides, the control unit 12 according to second embodiment additionally includes a ticket cancelling unit 201 and a ticket reselling unit 202.

If a request to cancel a ticket is received from the handheld device 2 of the possessor of that ticket, then the ticket cancelling unit 201 changes the mapping of the QR code corresponding to that ticket from the ticket possessor who requested cancellation to the ticket selling website 3A serving as the ticket supplier. That is, if a request to cancel a ticket is received from the handheld device 2 of the possessor of that ticket, then the to-be-cancelled ticket is temporarily held by the ticket selling website 3A. Then, the ticket cancelling unit 201 instructs the ticket reselling unit 202 (described later) to offer the to-be-cancelled ticket for resale.

When a request indicating the desire to purchase a to-be-cancelled ticket is received from the handheld device 2 of a new purchaser, the ticket cancelling unit 201 generates a new QR code corresponding to that ticket and stores the new QR code in the management DB 111 in a corresponding manner to the new purchaser. Herein, the ticket cancelling unit 201 stores the information on the new QR code and the seat information of the to-be-cancelled ticket in the management DB 111 in a corresponding manner to the user information of the new purchaser. Then, the ticket cancelling unit 201 invalidates the QR code corresponding to the ticket selling website 3A that serves as the ticket supplier, as well as validates the new QR code. That is, if a new purchaser shows up in response to the offer for resale, then the QR code of the ticket selling website 3A becomes invalid and a new QR code is given to the new purchaser.

However, on the other hand, if a request indicating the desire to purchase a to-be-cancelled ticket is not received, then the ticket cancelling unit 201 changes the mapping of the QR code corresponding to that ticket from the ticket selling website 3A to the original purchaser of that ticket. That is, if no purchaser shows up in response to the offer for resale, then the original purchaser of that ticket again becomes the possessor.

Moreover, if a notification for dropping the ticket cancellation request is received, the ticket cancelling unit 201 changes the mapping of the QR code corresponding to that ticket from the ticket selling website 3A to the original purchaser of that ticket. That is, when a notification for dropping the ticket cancellation request is received, the original purchaser of that ticket again becomes the possessor in an identical manner to the case when no purchaser shows up in response to the offer for resale. Meanwhile, the details of the ticket cancelling unit 201 are described later.

The ticket reselling unit 202 offers for resale the ticket for which a ticket cancellation request is received. For example, the ticket reselling unit 202 writes a notification, about the offer for resale of the ticket for which a ticket cancellation request is received, on a ticket information website dedicated for the ticket selling website 3A or on a generalized ticket information website.

In this way, the ticket cancelling unit 201 makes the supplier (the ticket selling website 3A) mediate for the trade of a ticket for which a ticket cancellation request is received. Hence, the ticket cancelling unit 201 can trade the ticket without having to make the new purchaser and the original purchaser directly communicate with each other. Thus, the new purchaser and the original purchaser do not have to communicate the personal information to each other. Hence, the ticket can be traded in a safe manner.

Moreover, the ticket cancelling unit 201 makes the supplier mediate for the trade of a ticket for which a ticket cancellation request is received. Hence, the ticket cancelling unit 201 can trade the ticket without having to make the new purchaser and the original purchaser directly exchange money between each other. That is, the ticket reselling unit 202 serves as the supplier and offers for resale a ticket for which a ticket cancellation request is received. If a new purchaser shows up in response to the offer for resale, then the payment for the ticket from the new purchaser to the original purchaser is done via the supplier. As a result, the original purchaser can reliably receive the payment for the ticket from the new purchaser.

Furthermore, since the ticket cancelling unit 201 makes the supplier (the ticket selling website 3A) mediate for the sale of a ticket for which a ticket cancellation request is received, it becomes possible for the supplier to sale the ticket in a flexible manner. For example, if the supplier can ensure that the original purchaser provides cancellation information at an early stage, then the cancelled seat and other unsold seats can be sold as consecutive seats. Particularly, in the case when the supplier does not fix the seat information until very close to the event date (i.e., when the supplier delays the notice about seat information to the purchasers), consecutive seat selling can be done in an efficient manner.

Flowchart of Ticket Cancelling Operation

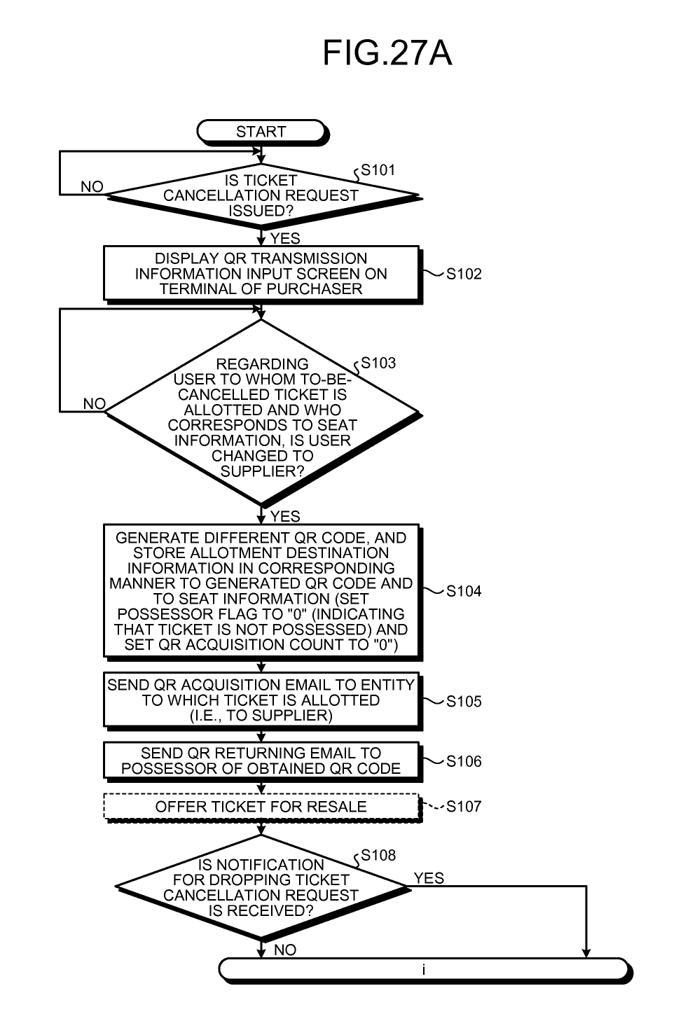

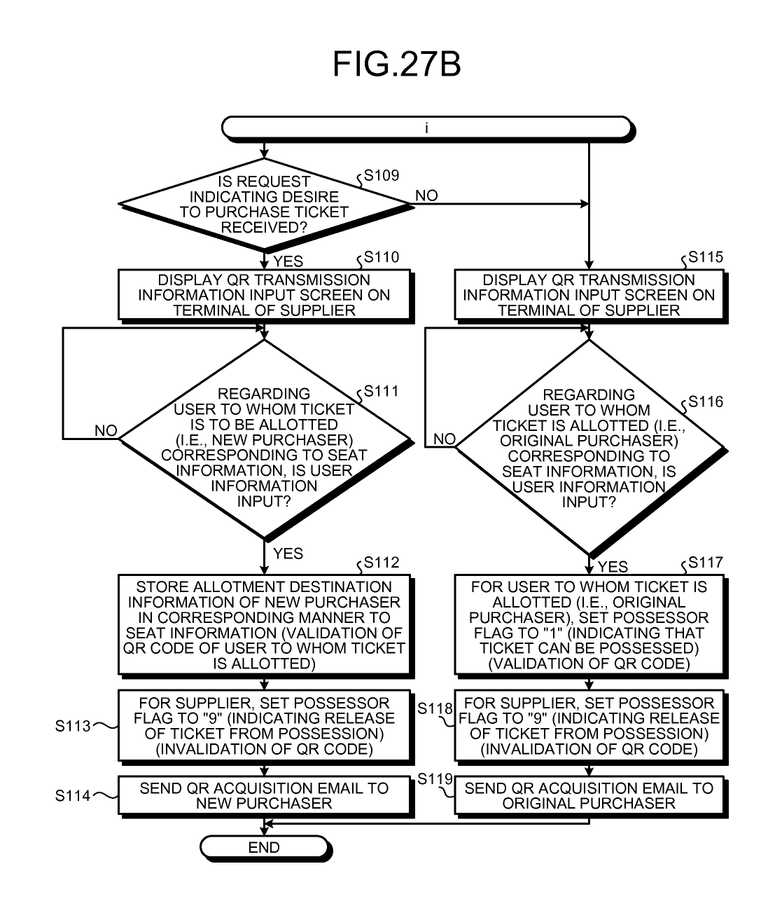

Explained below with reference to FIGS. 27A and 27B are flowcharts of a ticket cancelling operation. FIGS. 27A and 27B are flowcharts for explaining the ticket cancelling operation according to the second embodiment. Herein, for each user to whom a ticket is allotted by the original purchaser; QR code information, seat information, and user information is stored as part of ticket purchasing information. Moreover, for each such user, the possessor flag 111p is set to “1” (indicating that the ticket can be possessed) and the QR acquisition count 111l is set to “1”.

As illustrated in FIGS. 27A and 27B, the ticket cancelling unit 201 determines whether or not a user to whom a ticket is allotted issues a ticket cancellation request to the original purchaser of that ticket (Step S101). If it is determined that no ticket cancellation request is issued (No at Step S101), then the ticket cancelling unit 201 repeatedly performs the determination operation until a ticket cancellation request is issued.

On the other hand, when it is determined that a ticket cancellation request is issued (Yes at Step S101), the ticket cancelling unit 201 displays the QR transmission information input screen on the handheld device 2 of the original purchaser of that ticket (Step S102). Although the QR transmission information input screen is primarily used to input the user to whom a purchased ticket is to be allotted, herein it is used to change the user to whom the ticket has been allotted.

Then, the ticket cancelling unit 201 determines whether or not, corresponding to the seat information of the ticket for which the ticket cancellation request is issued, the user to whom the ticket is allotted is changed to the supplier (Step S103). For example, the ticket cancelling unit 201 determines whether or not the user to whom the ticket is allotted and who has been changed from the QR transmission information input screen has the telephone number and the email address of the supplier. If it is determined that the user to whom the ticket is allotted has not been changed to the supplier (No at Step S103), then the ticket cancelling unit 201 repeatedly performs the determination operation until the user to whom the ticket is allotted is changed to the supplier.

On the other hand, when the user to whom the ticket is allotted is changed to the supplier (Yes at Step S103), the ticket cancelling unit 201 generates a QR code that is different from the QR code corresponding to the seat information of the ticket for which the ticket cancellation request is issued. Then, the ticket cancelling unit 201 stores the allotment destination information in a corresponding manner to the generated QR code and the seat information (Step S104). At that time, the ticket cancelling unit 201 sets the possessor flag 111p to “0” (indicating that the ticket is not possessed) and sets the QR acquisition count 111l to “0”.

Subsequently, the ticket cancelling unit 201 sends a QR acquisition email to the email address of the entity to which the ticket is allotted (i.e., to the ticket selling website 3A) (Step S105). At the same time, the ticket cancelling unit 201 sends a QR returning email to the possessor of the obtained QR code (Step S106). That is, the ticket cancelling unit 201 sends an email to the possessor of the ticket for which the ticket cancellation request is received, and prompts that possessor to return the QR code.

Then, the ticket cancelling unit 201 instructs the ticket reselling unit 202 to offer the ticket, for which the ticket cancellation request was issued, for resale (Step S107).

Subsequently, the ticket cancelling unit 201 determines whether or not a notification for dropping the ticket cancellation request is received from the original purchaser of the ticket (Step S108). If it is determined that a notification for dropping the ticket cancellation request is not received (No at Step S108), then the ticket cancelling unit 201 determines whether or not a request indicating the desire to purchase the ticket is received (Step S109).

If it is determined that a request indicating the desire to purchase the ticket is received (Yes at Step S109), then the ticket cancelling unit 201 displays the QR transmission information input screen on a terminal of the supplier (Step S110). Subsequently, the ticket cancelling unit 201 determines whether or not the user information of the user to whom the ticket is to be allotted (i.e., the new purchaser) corresponding to the seat information is input (Step S111). If it is determined that the user information of the user to whom the ticket is to be allotted (i.e., the new purchaser) is not input (No at Step S111), then the ticket cancelling unit 201 repeatedly performs the determination operation until the user information of the user to whom the ticket is to be allotted (i.e., the new purchaser) is input.

On the other hand, when the user information of the user to whom the ticket is to be allotted (i.e., the new purchaser) is input (Yes at Step S111), the ticket cancelling unit 201 stores the user to whom the ticket is to be allotted (i.e., the new purchaser) in a corresponding manner to the seat information (Step S112). At that time, the ticket cancelling unit 201 sets the possessor flag 111p to “1” (indicating that the ticket can be possessed) and sets the QR acquisition count 111l to “0”. With that, the ticket cancelling unit 201 validates the QR code corresponding to the seat information under consideration. Subsequently, in the record of the supplier, the ticket cancelling unit 201 sets the possessor flag 111p to “9” (indicating release of the ticket from possession) (Step S113). With that, the ticket cancelling unit 201 invalidates the QR code corresponding to the supplier.

Then, the ticket cancelling unit 201 sends a QR acquisition email to the email address of the user to whom the ticket is to be allotted (i.e., the new purchaser) (Step S114). Subsequently, the ticket cancelling unit 201 ends the ticket cancelling operation.

Meanwhile, if it is determined that a notification for dropping the ticket cancellation request is received (Yes at Step S108) or if it is determined that a request indicating the desire to purchase the ticket is not received (No at Step S109), then the ticket cancelling unit 201 displays the QR transmission information input screen on the terminal of the supplier (Step S115).

Subsequently, the ticket cancelling unit 201 determines whether or not the user information of the user to whom the ticket is allotted (i.e., the original purchaser) corresponding to the seat information is input (Step S116). If it is determined that the user information of the user to whom the ticket is allotted (i.e., the original purchaser) is not input (No at Step S116), then the ticket cancelling unit 201 repeatedly performs the determination operation until the user information of the user to whom the ticket is allotted (i.e., the original purchaser) is input.

On the other hand, when it is determined that the user information of the user to whom the ticket is allotted (i.e., the original purchaser) is input (Yes at Step S116), then the ticket cancelling unit 201 sets the possessor flag 111p to “1” (indicating that the ticket can be possessed) in the record of the user to whom the ticket is allotted (i.e., the original purchaser) (Step S117). With that, the ticket cancelling unit 201 validates the QR code corresponding to the user to whom the ticket is allotted (i.e., the original purchaser). Subsequently, the ticket cancelling unit 201 sets the possessor flag 111p to “9” (indicating release of the ticket from possession) in the record of the supplier (Step S118). With that, the ticket cancelling unit 201 invalidates the QR code corresponding to the supplier.

Then, the ticket cancelling unit 201 sends a QR acquisition email to the email address of the user to whom the ticket is allotted (i.e., the original purchaser) (Step S119). Then, the ticket cancelling unit 201 ends the ticket cancelling operation.

Sequence of Operations Performed when Ticket Cancelled by Possessor could be Transferred to New Purchaser

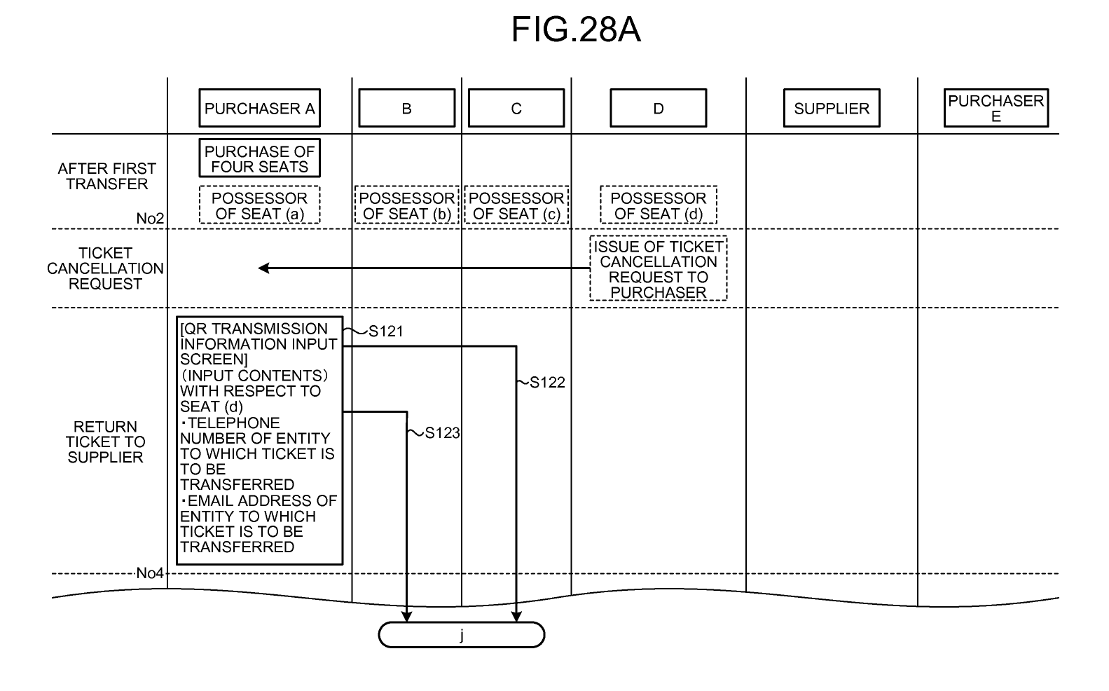

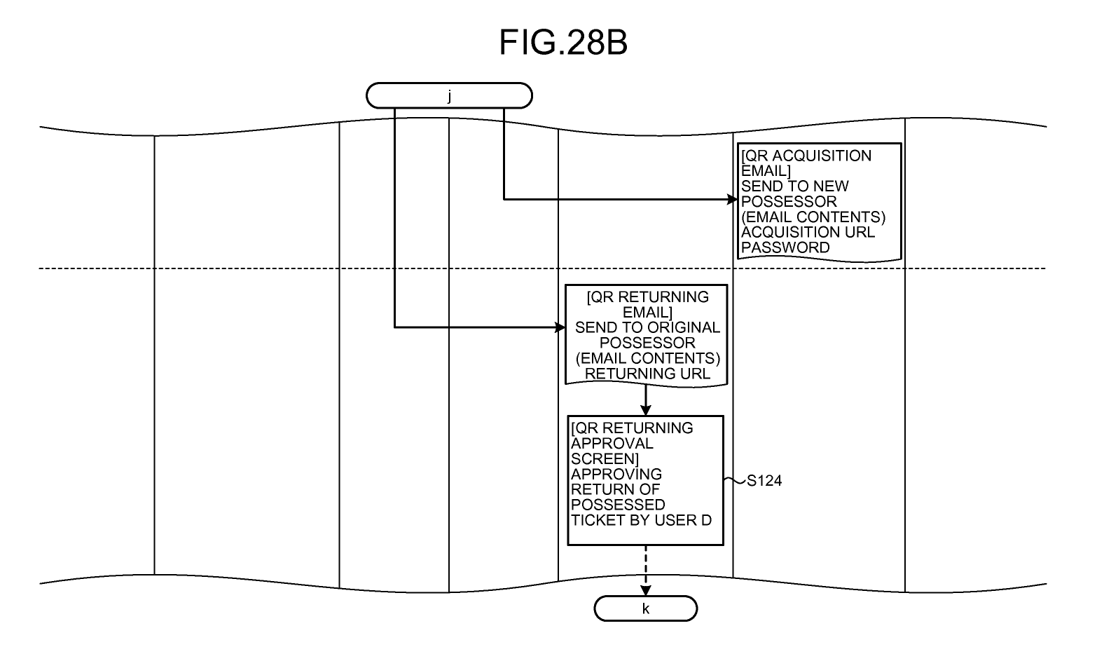

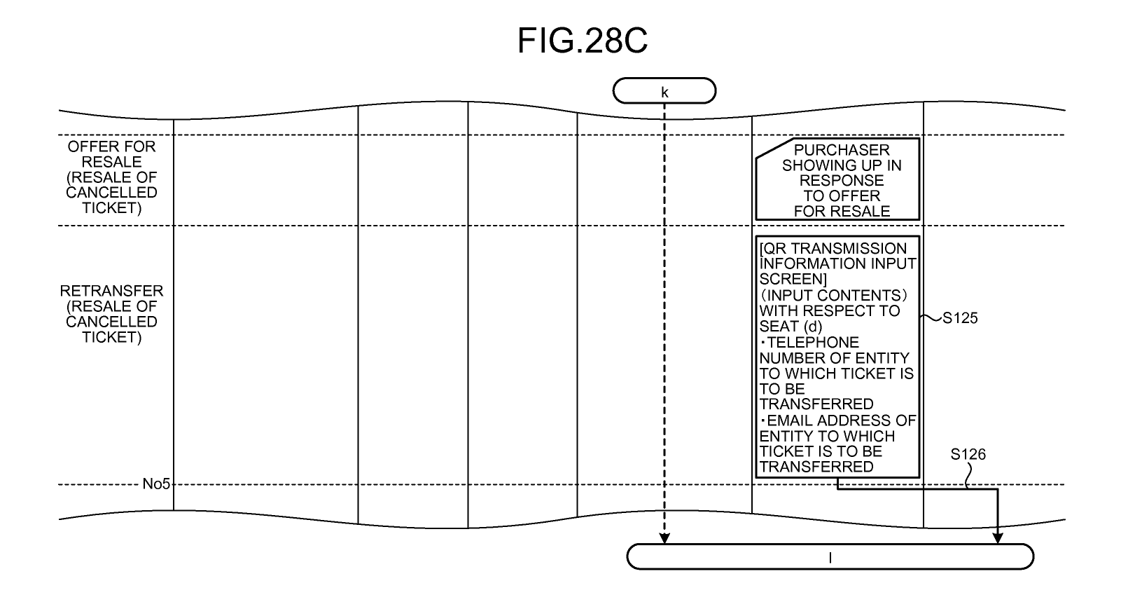

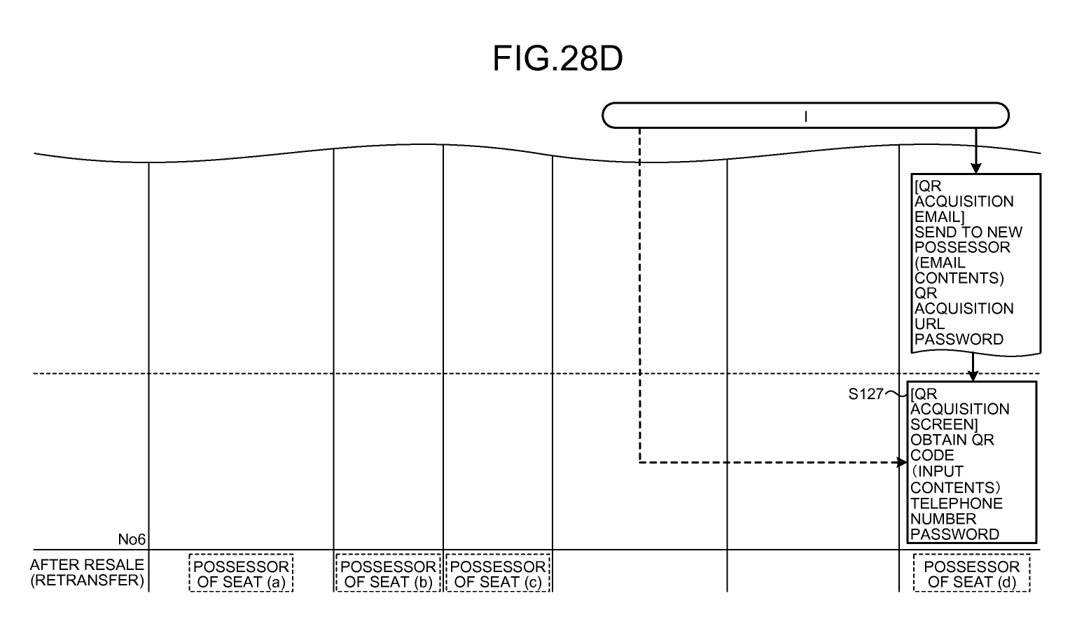

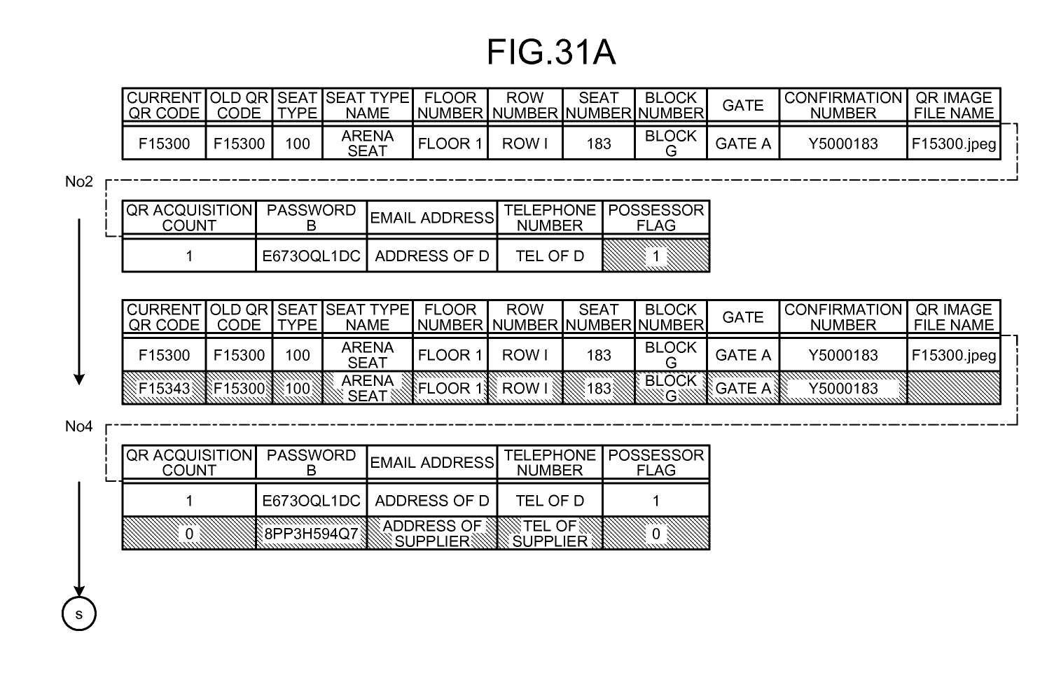

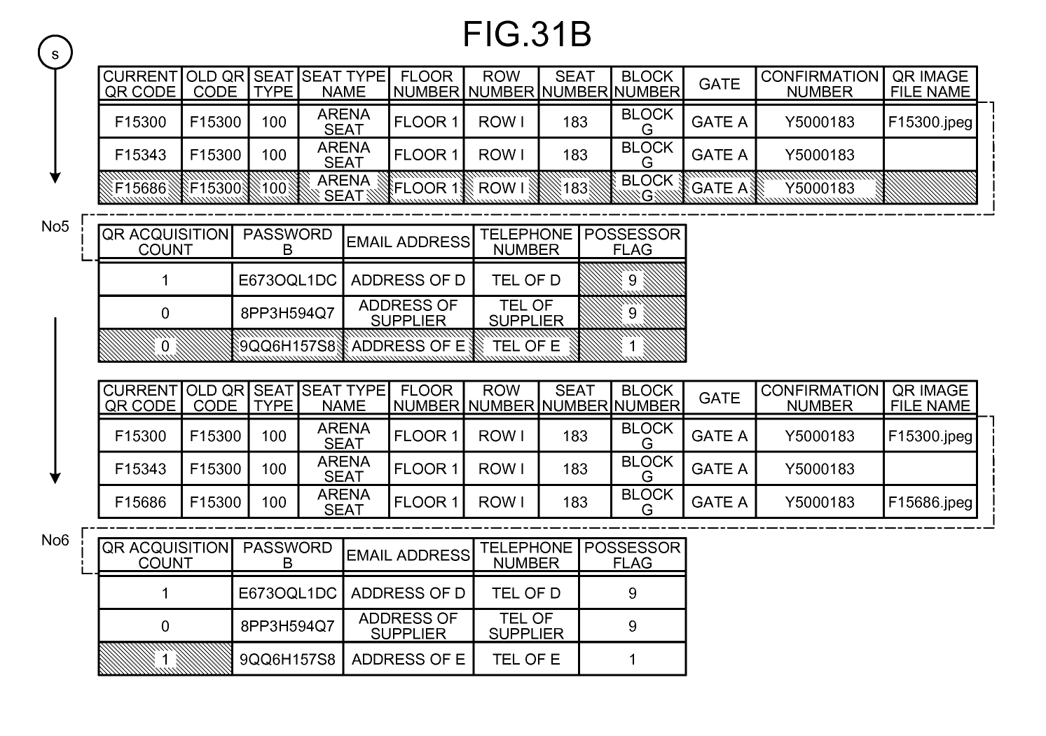

A sequence of operations performed in the case when the ticket cancelled by a possessor could be transferred to a new purchaser is explained below with reference to the database content of the management DB 111. FIGS. 28A, 28B, 28C and 28D are sequence diagrams for explaining a sequence of operations performed in the case when the ticket cancelled by a possessor could be transferred to a new purchaser. With reference to FIGS. 28A, 28B, 28C and 28D, it is assumed that the purchaser A purchases four seats and becomes the possessor of the seat a. Moreover, it is assumed that, users B, C, and D to whom seats are allotted become the possessors of seats b, c, and d, respectively. The following explanation is given for a case in which the user D to whom the seat d is allotted issues a ticket cancellation request for cancelling the seat d. Consequently, the supplier offers the seat d for resale, and transfers the seat d to a new purchaser E who shows up in response to the offer for resale. Meanwhile, the following explanation is given with reference to the record of the seat d (floor 1, row I, 183) maintained in the management DB 111 as illustrated in FIG. 31.

After the user D, to whom the seat d is allotted, issues a ticket cancellation request to the purchaser A for cancelling the seat d; the ticket cancelling unit 201 displays the QR transmission information input screen (Step S121).

At that point of time, in the management DB 111, the record of the seat d has “address of D” set as the email address 111n; has “TEL of D” set as the telephone number 111o; has “1” set as the possessor flag 111p (indicating that the ticket can be possessed); and has “1” set as the QR acquisition count 111l (see No2 in FIG. 31).

From the QR transmission information input screen, the purchaser A inputs the email address and the telephone number of the supplier by considering the supplier as the entity to which the seat d is to be allotted. In response, the ticket cancelling unit 201 adds in the management DB 111 the record of the supplier as the entity to which the seat d is to be allotted. That is, the ticket cancelling unit 201 considers the supplier to be the entity that temporarily holds the ticket of the seat d.

Herein, in the record added in the management DB 111, “F15343” is set in the newly-generated current QR code 111a; “address of supplier” is set in the email address 111n; “TEL of supplier” is set in the telephone number 111o; “0” is set in the possessor flag 111p (indicating that the ticket is not possessed); and “0” is set in the QR acquisition count 111l (see No4 in FIG. 31).

Then, the ticket cancelling unit 201 sends a QR acquisition email to the email address of the entity to which the seat d is transferred (i.e., the supplier) (Step S122). At that same time, the ticket cancelling unit 201 sends a QR returning email to the user D who is the current possessor of the seat d (Step S123).

When the user D accesses the QR returning URL, the QR returning unit 122 displays a QR returning approval screen (Step S124). Then, from the QR returning approval screen, the user D issues a QR returning approval corresponding to the seat d. In response, in the record of the user D, the QR returning unit 122 sets the possessor flag 111p to “9” (indicating release of the ticket from possession). At the same time, in the record of the supplier, the QR returning unit 122 sets the possessor flag 111p to “1” (indicating that the ticket can be possessed) (not illustrated in FIG. 31). With that, the QR returning unit 122 invalidates the QR code corresponding to the user D, but validates the QR code corresponding to the supplier. As a result, the user D is no more the possessor of the seat d; while the supplier becomes the temporary possessor of the seat d.

Then, the ticket selling website 3A that serves as the supplier offers the ticket of the seat (d), for which a ticket cancellation request is issued, for resale. Herein, it is assumed that, from the handheld device 2 of the purchaser E, the ticket cancelling unit 201 receives a request indicating the desire to purchase the ticket for which a ticket cancellation request is issued.

In response, the ticket cancelling unit 201 displays the QR transmission information input screen on the terminal of the supplier (Step S125). Then, from the QR transmission information input screen, the supplier inputs the telephone number and the email address of the purchaser E as the user to whom the seat d is to be transferred. Accordingly, in the management DB 111, the ticket cancelling unit 201 adds the record of the purchaser E as the user to whom the seat d is to be transferred.

Herein, in the record added in the management DB 111, “F15686” is set in the newly-generated current QR code 111a; “address of E” is set in the email address 111n; “TEL of E” is set in the telephone number 111o; “1” is set in the possessor flag 111p (indicating that the ticket can be possessed); and “0” is set in the QR acquisition count 111l (see No5 in FIG. 31). Besides, in the record of the supplier, the ticket cancelling unit 201 sets the possessor flag 111p to “9” (indicating release of the ticket from possession) (see No5 in FIG. 31).

Then, the ticket cancelling unit 201 sends a QR acquisition email to the email address of the purchaser E (Step S126).

Subsequently, when the purchaser E accesses the QR acquisition URL, the QR displaying unit 123 displays the QR acquisition screen (Step S127). Then, from the QR acquisition screen, the purchaser E inputs the telephone number and the password thereof. If the telephone number and the password that are input match with the telephone number 111o and the password B 111m, respectively, corresponding to the purchaser E in the management DB 111; then the QR displaying unit 123 determines that the purchaser E is legitimate. Moreover, if the possessor flag 111p corresponding to the purchaser E is set to “1” (indicating that the ticket can be possessed), then the QR displaying unit 123 sets “1” in the QR acquisition count 111l in the record of the purchaser E (see No6 in FIG. 31). Then, the QR displaying unit 123 displays a QR code to the purchaser E.

As a result, the possessor of the seat d is changed from the supplier to the purchaser E.

Sequence of Operations Performed when Ticket Cancellation Request Issued by Possessor is Followed by Dropping of Ticket Cancellation Request

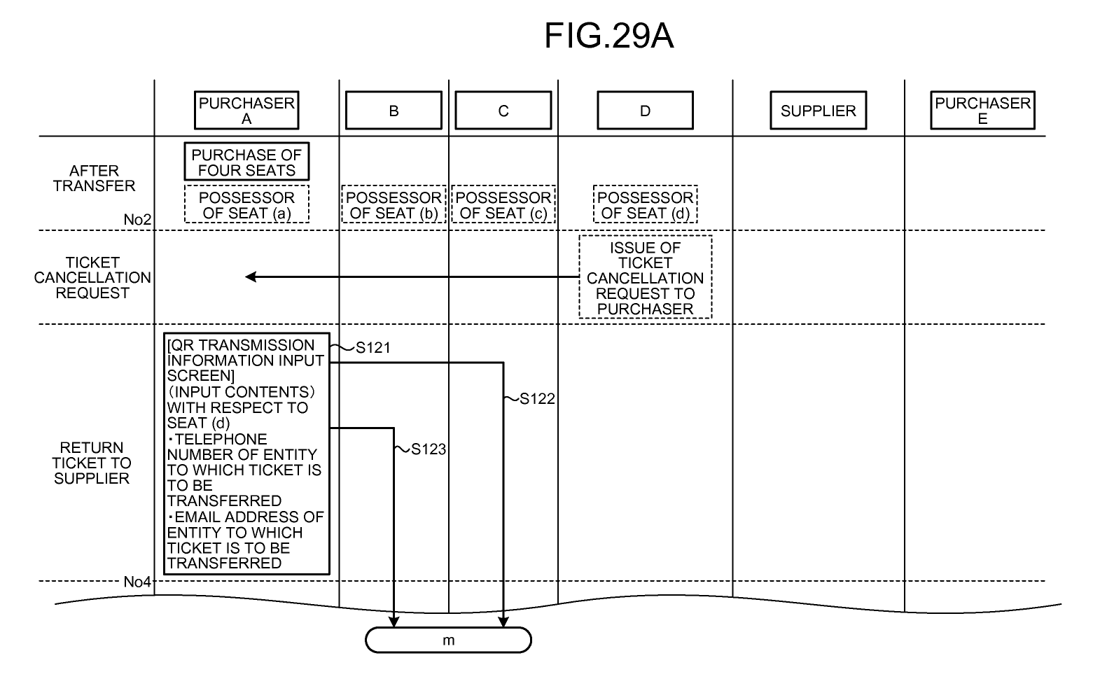

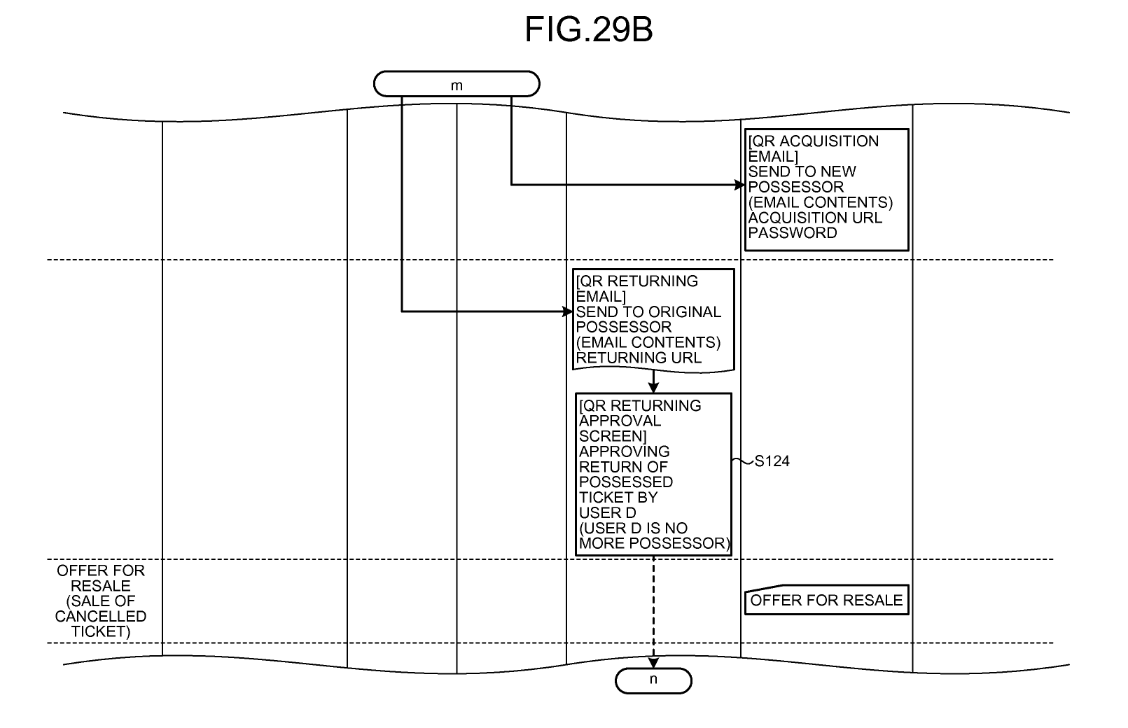

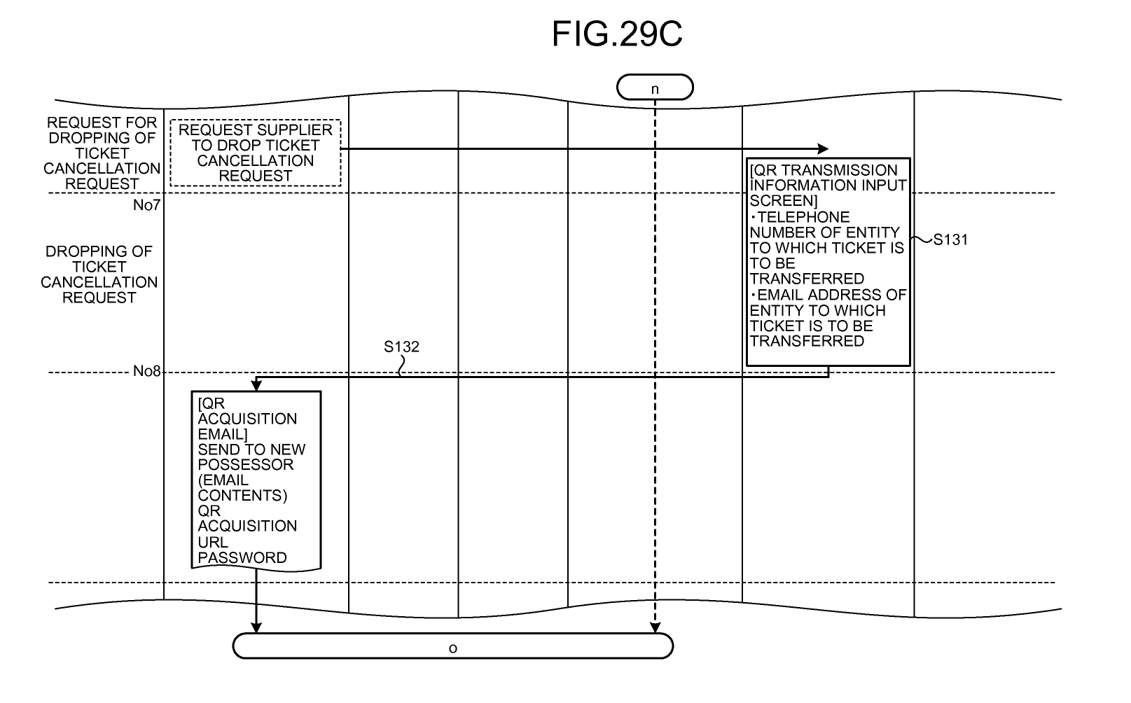

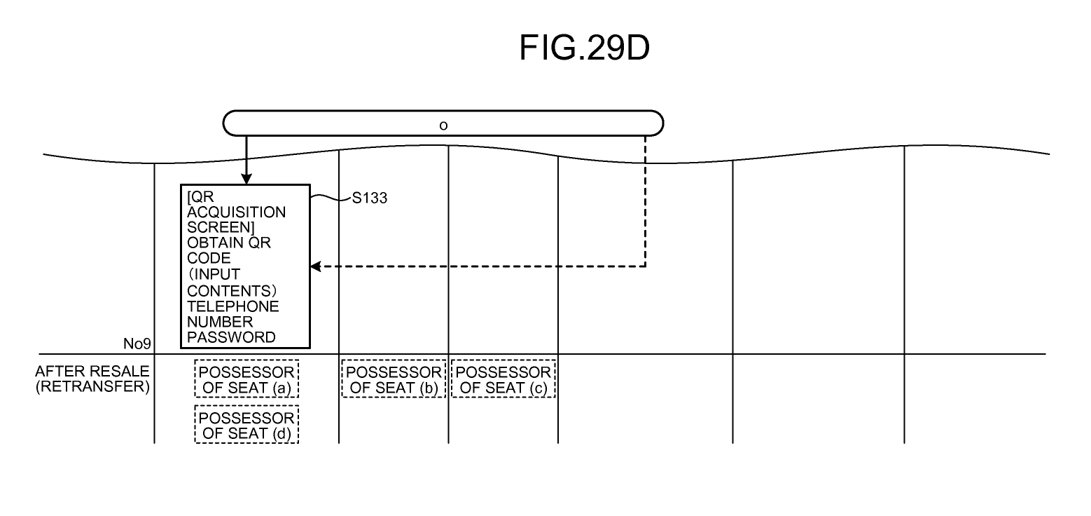

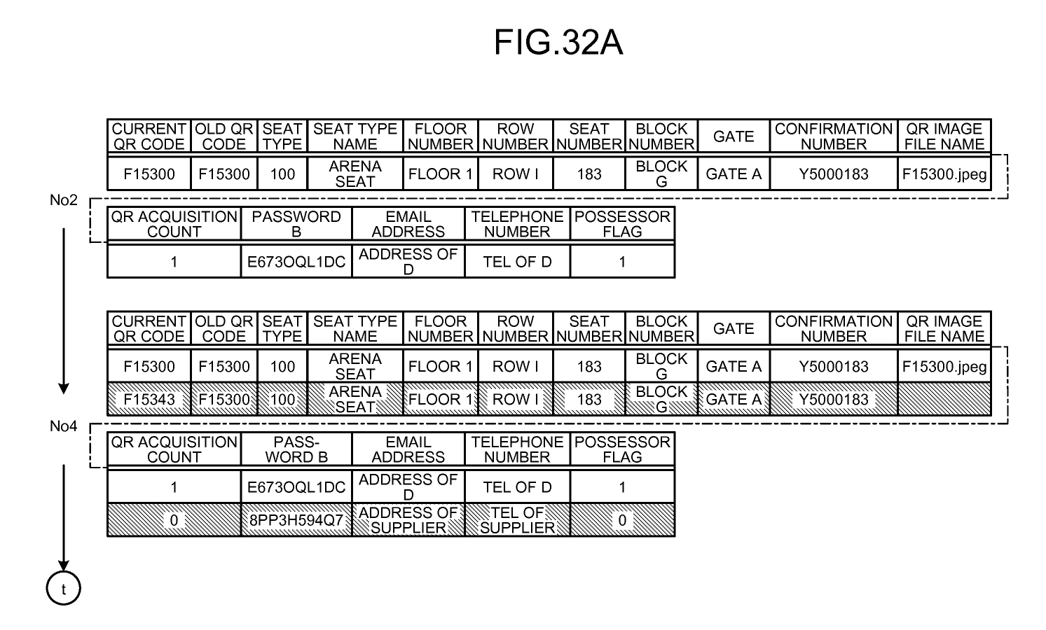

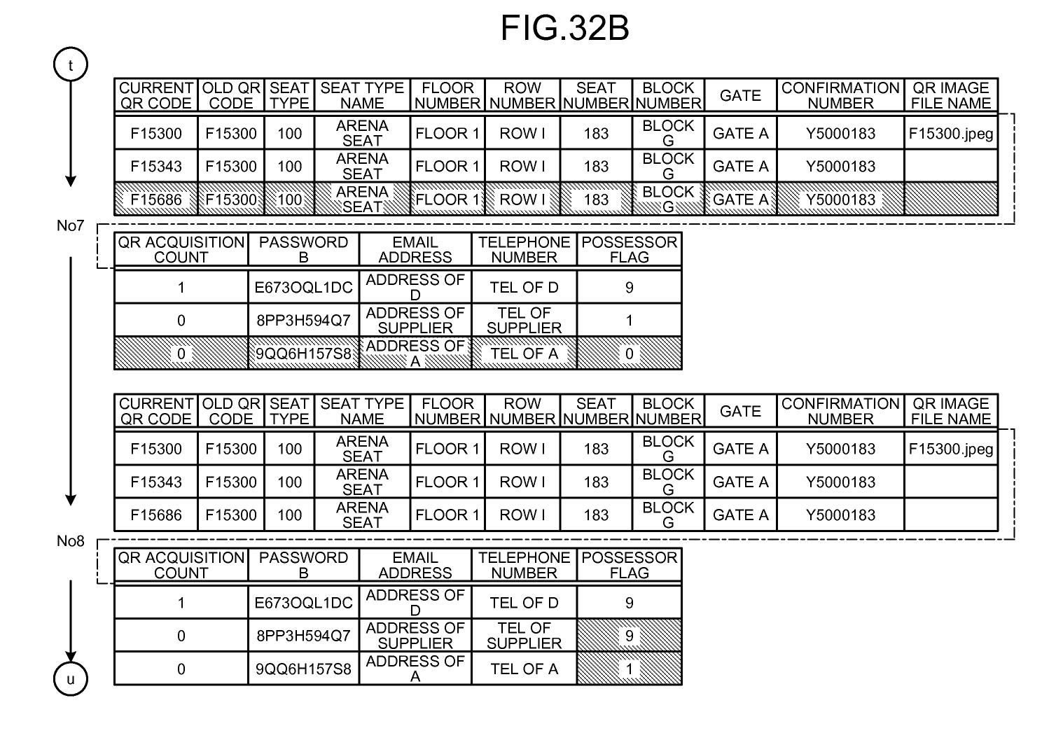

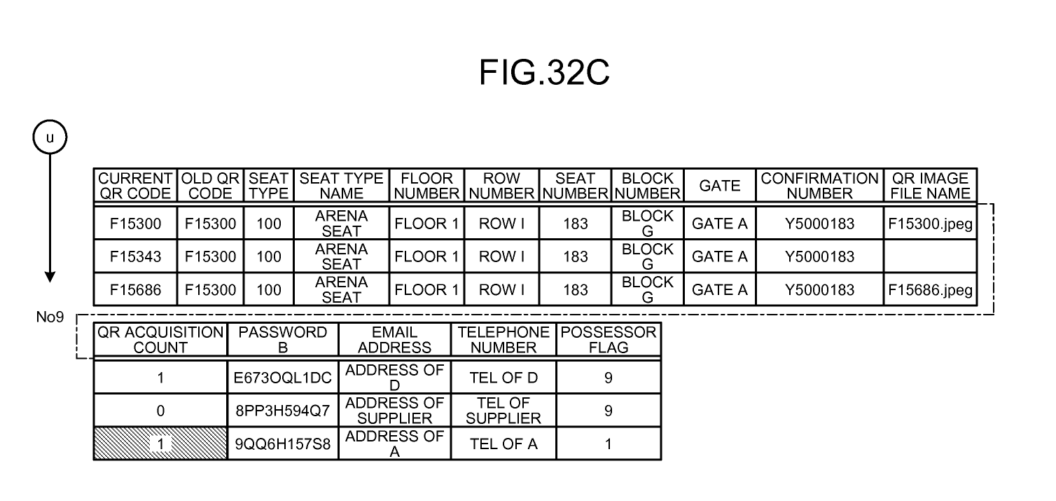

A sequence of operations performed in the case when a possessor cancels the ticket but then drops the ticket cancellation request is explained below with reference to the database content of the management DB 111. FIGS. 29A, 29B, 29C and 29D are sequence diagrams for explaining a sequence of operations performed in the case when a possessor cancels the ticket but then drops the ticket cancellation request. Herein, the operations identical to the operations performed during the sequences of operations illustrated in FIGS. 28A, 28B, 28C and 28D are referred to by the same step numbers, and the explanation thereof is not repeated. Meanwhile, the following explanation is given with reference to the record of the seat d (floor 1, row I, 183) maintained in the management DB 111 as illustrated in FIG. 32.

After the user D, to whom the seat d is allotted, issues a ticket cancellation request to the purchaser A for cancelling the seat d; the ticket cancelling unit 201 sends a QR acquisition email to the email address of the supplier and sends a QR returning email to the user D who is the current possessor of the seat d (Step S121 to Step S123). When the user D accesses the QR returning URL, the QR returning unit 122 displays the QR returning approval screen, and the user D issues a QR returning approval from the QR returning approval screen (Step S124). In response, the possessor flag 111p is set to “9” (indicating release of the ticket from possession) in the record of the user D, and the possessor flag 111p is set to “1” (indicating that the ticket can be possessed) in the record of the supplier (see No7 in FIG. 32). As a result, the user D is no more the possessor of the seat d; while the supplier becomes the temporary possessor of the seat d.

Then, the ticket selling website 3A that serves as the supplier offers the ticket of the seat (d), for which a ticket cancellation request is issued, for resale. However, herein it is assumed that the supplier receives a request from the purchaser A for dropping the ticket cancellation request.

In response, the ticket cancelling unit 201 adds in the management DB 111 the record of the original purchaser A as the user to which the seat d is to be transferred.

Herein, in the record added in the management DB 111, “F15686” is set in the newly-generated current QR code 111a; “address of A” is set in the email address 111n; “TEL of A” is set in the telephone number 111o; “0” is set in the possessor flag 111p (indicating that the ticket is not possessed); and “0” is set in the QR acquisition count 111l (see No7 in FIG. 32).

Then, the ticket cancelling unit 201 displays the QR transmission information input screen on the terminal of the supplier (Step S131). From the QR transmission information input screen, the supplier inputs the telephone number and the email address of the original purchaser A to whom the seat d is to be transferred. In response, in the record of the original purchaser A, the ticket cancelling unit 201 sets the possessor flag 111p to “1” (indicating that the ticket can be possessed) (see No7 in FIG. 32). In addition, in the record of the supplier, the ticket cancelling unit 201 sets the possessor flag 111p to “9” (indicating release of the ticket from possession) (see No8 in FIG. 32).

Then, the ticket cancelling unit 201 sends a QR acquisition email to the email address of the original purchaser A (Step S132).

Subsequently, when the original purchaser A accesses the QR acquisition URL, the QR displaying unit 123 displays the QR acquisition screen (Step S133). Then, from the QR acquisition screen, the original purchaser A inputs the telephone number and the password thereof. If the telephone number and the password that are input match with the telephone number 111o and the password B 111m, respectively, corresponding to the original purchaser A in the management DB 111; the QR displaying unit 123 determines that the original purchaser A is legitimate. Moreover, if the possessor flag 111p corresponding to the original purchaser A is set to “1” (indicating that the ticket can be possessed), then the QR displaying unit 123 sets “1” in the QR acquisition count 111l in the record of the original purchaser A (see No9 in FIG. 32). Then, the QR displaying unit 123 displays a QR code to the original purchaser A.

As a result, the possessor of the seat d is restored to the original purchaser A from the supplier.

Sequence of Operations Performed when Ticket Cancelled by Possessor could not be Transferred to New Purchaser

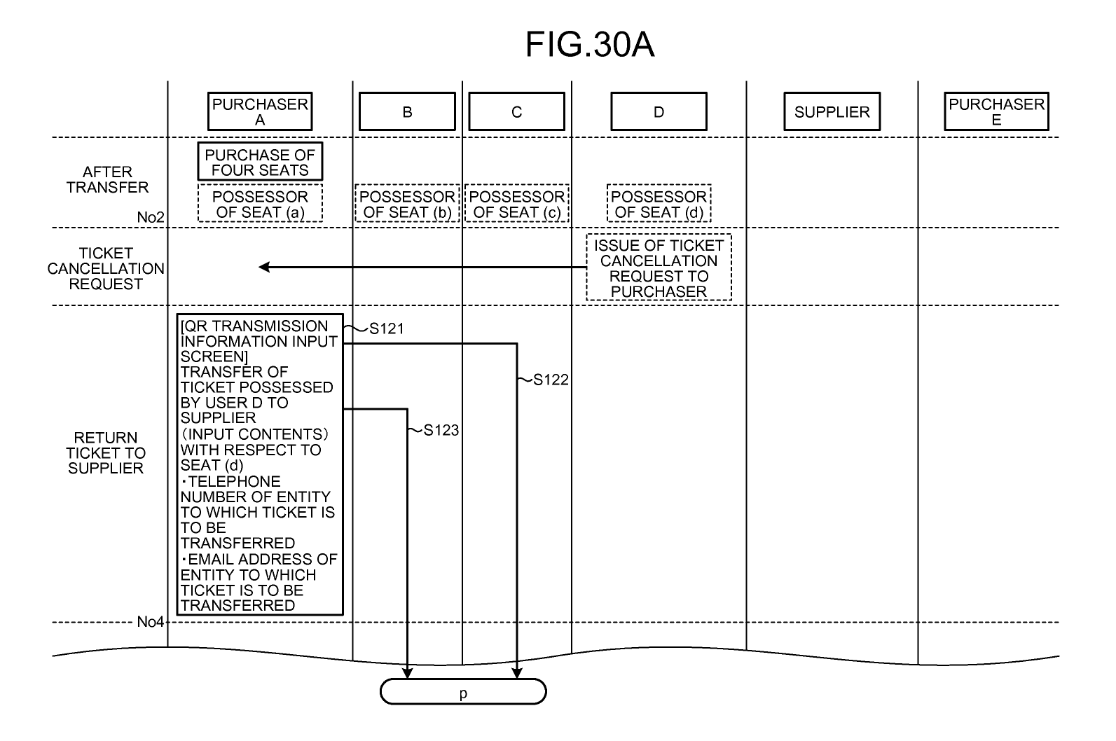

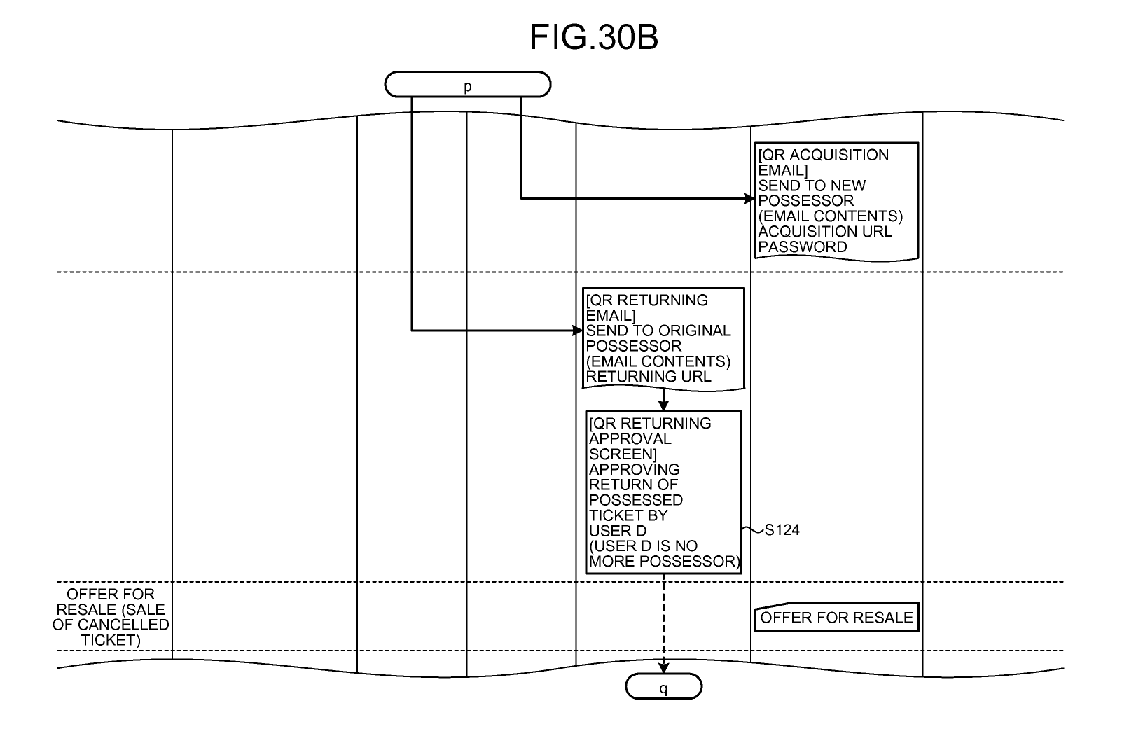

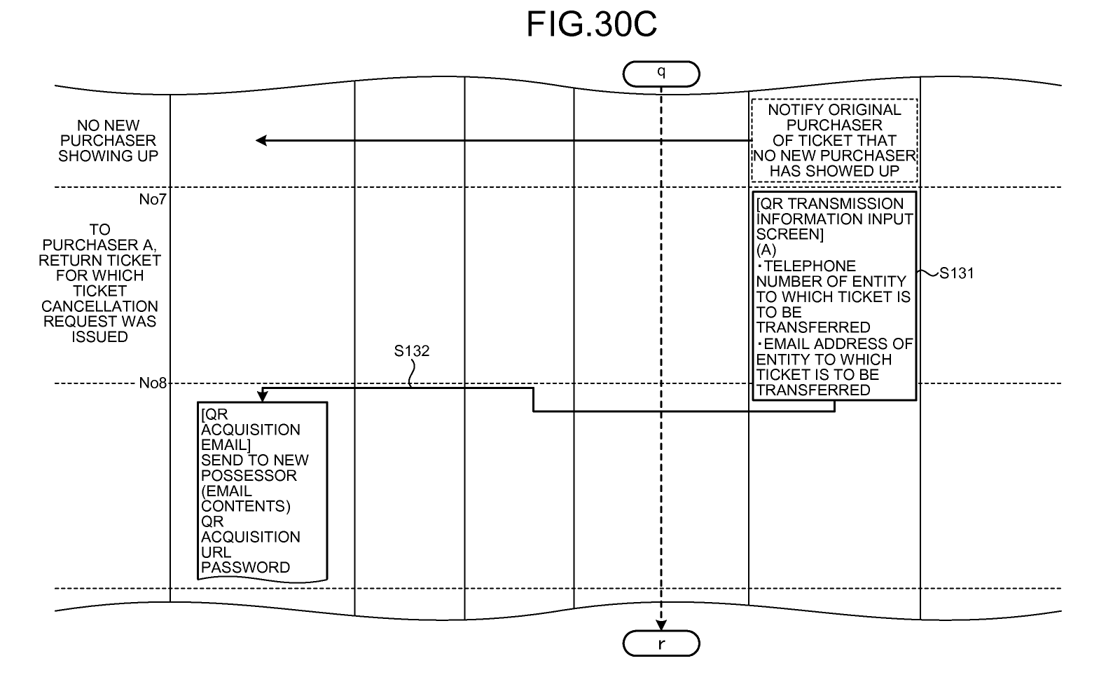

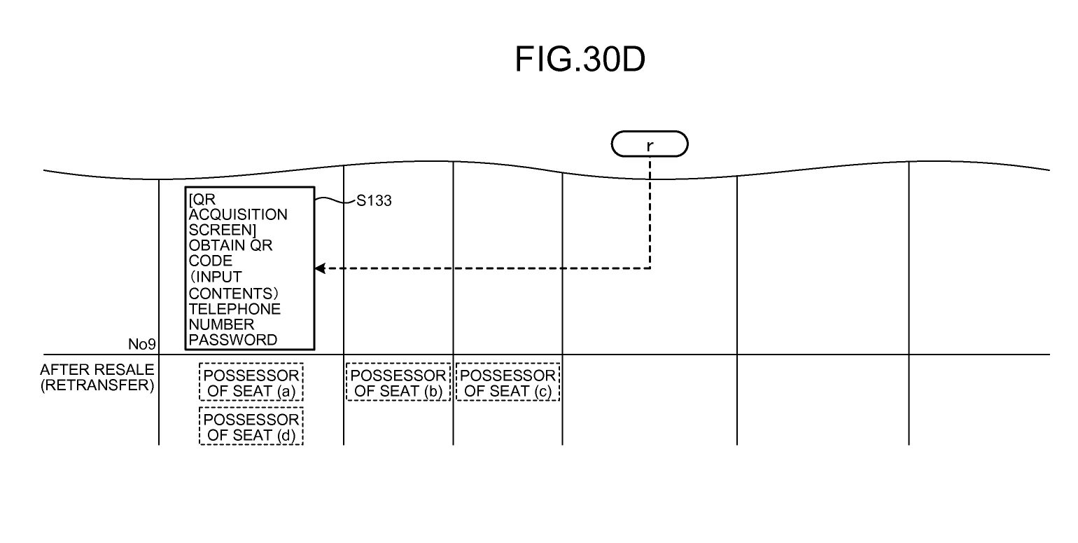

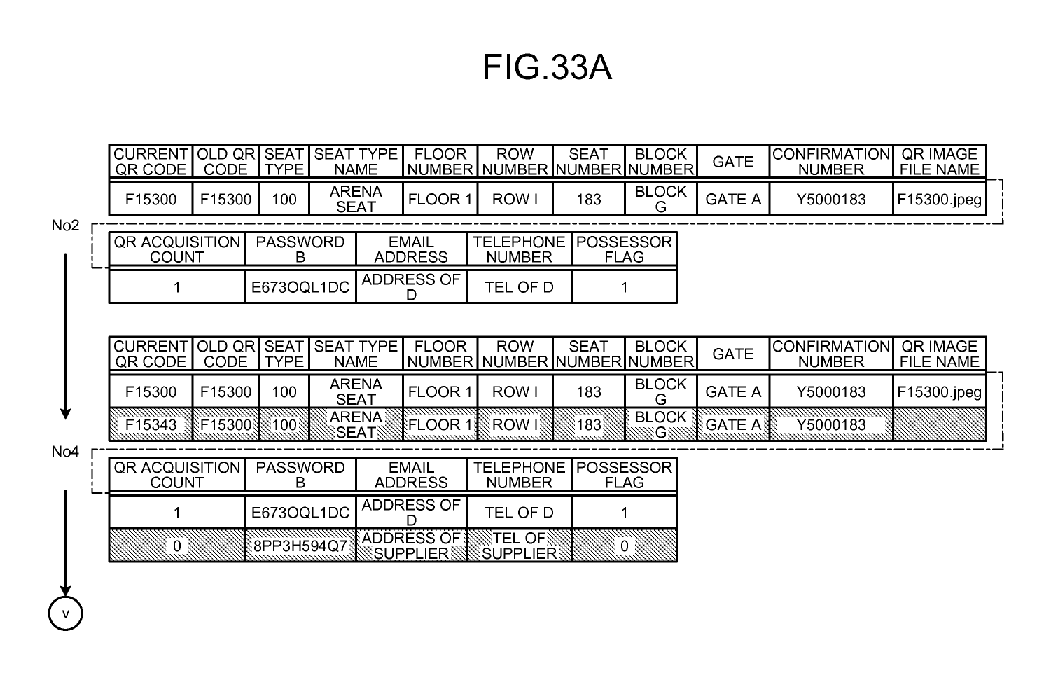

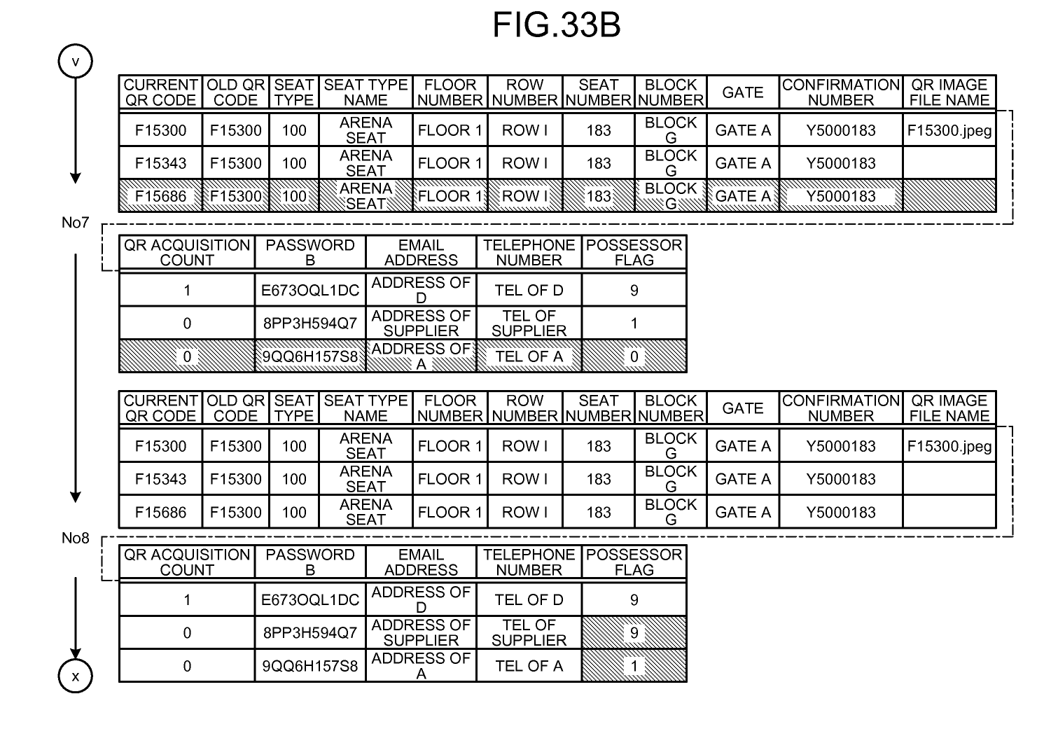

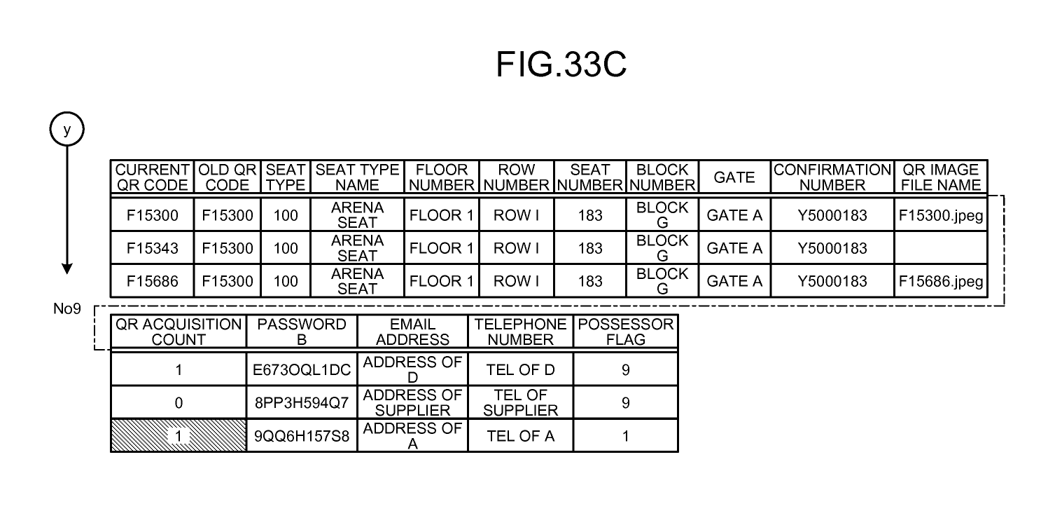

A sequence of operations performed in the case when the ticket cancelled by a possessor could not be transferred to a new purchaser is explained below with reference to the database content of the management DB 111. FIGS. 30A, 30B, 30C and 30D are sequence diagrams for explaining a sequence of operations performed in the case when the ticket cancelled by a possessor could not be transferred to a new purchaser. Herein, the operations identical to the operations performed during the sequences of operations illustrated in FIGS. 28A, 28B, 28C and 28D are referred to by the same step numbers, and the explanation thereof is not repeated. Meanwhile, the following explanation is given with reference to the record of the seat d (floor 1, row I, 183) maintained in the management DB 111 as illustrated in FIG. 33.

After the user D, to whom the seat d is allotted, issues a ticket cancellation request to the purchaser A for cancelling the seat d; the ticket cancelling unit 201 sends a QR acquisition email to the email address of the supplier and sends a QR returning email to the user D who is the current possessor of the seat d (Step S121 to Step S123). When the user D accesses the QR returning URL, the QR returning unit 122 displays the QR returning approval screen, and the user D issues a QR returning approval from the QR returning approval screen (Step S124). In response, the possessor flag 111p is set to “9” (indicating release of the ticket from possession) in the record of the user D, and the possessor flag 111p is set to “1” (indicating that the ticket can be possessed) in the record of the supplier (see No8 in FIG. 33). As a result, the user D is no more the possessor of the seat d; while the supplier becomes the temporary possessor of the seat d.

Then, the ticket selling website 3A that serves as the supplier offers the ticket of the seat (d), for which a ticket cancellation request is issued, for resale. Herein, it is assumed that the supplier does not receive a request from the purchaser for dropping the ticket cancellation request.

In response, the ticket cancelling unit 201 adds in the management DB 111 the record of the original purchaser A as the user to which the seat d is to be transferred.

Herein, in the record added in the management DB 111, “F15686” is set in the newly-generated current QR code 111a; “address of A” is set in the email address 111n; “TEL of A” is set in the telephone number 111o; “0” is set in the possessor flag 111p (indicating that the ticket is not possessed); and “0” is set in the QR acquisition count 111l (see No7 in FIG. 33).

Then, the ticket cancelling unit 201 displays the QR transmission information input screen on the terminal of the supplier (Step S131). From the QR transmission information input screen, the supplier inputs the telephone number and the email address of the original purchaser A to whom the seat d is to be transferred. In response, the ticket cancelling unit 201 sets the possessor flag 111p to “1” (indicating that the ticket can be possessed) in the record of the original purchaser A (see No7 in FIG. 33). In addition, the ticket cancelling unit 201 sets the possessor flag 111p to “9” (indicating release of the ticket from possession) in the record of the supplier (see No8 in FIG. 33).

Then, the ticket cancelling unit 201 sends a QR acquisition email to the email address of the original purchaser A (Step S132).

Subsequently, when the original purchaser A accesses the QR acquisition URL, the QR displaying unit 123 displays the QR acquisition screen (Step S133). Then, from the QR acquisition screen, the original purchaser A inputs the telephone number and the password thereof. If the telephone number and the password that are input match with the telephone number 111o and the password B 111m, respectively, corresponding to the original purchaser A in the management DB 111; the QR displaying unit 123 determines that the original purchaser A is legitimate. Moreover, if the possessor flag 111p corresponding to the original purchaser A is set to “1” (indicating that the ticket can be possessed), then the QR displaying unit 123 sets “1” in the QR acquisition count 111l in the record of the original purchaser A (see No9 in FIG. 33). Then, the QR displaying unit 123 displays a QR code to the original purchaser A.

As a result, the possessor of the seat d is restored to the original purchaser A from the supplier.

### Effect of Second Embodiment

According to the second embodiment, from the handheld device 2 of the user to whom a ticket corresponding to validated image code is allotted, the server 30 receives a ticket cancellation request. In response, the server 30 changes the mapping of the image code from the user who requested cancellation to the supplier (i.e., the ticket selling website 3A). Subsequently, when a request indicating the desire to purchase a to-be-cancelled ticket is received from the handheld device 2 of a new purchaser, the server 30 generates new image code; invalidates the image code corresponding to the ticket cancellation request; and validates the new image code. In this way, the server 30 makes the supplier mediate for the trade of a ticket for which a ticket cancellation request is received. Hence, the server 30 can trade the ticket, for which a ticket cancellation request is received, without having to make the original purchaser, who had allotted the ticket, and the new purchaser directly communicate with each other.

Moreover, according to the second embodiment, if a request indicating the desire to purchase a to-be-cancelled ticket is not received, the server 30 changes the mapping of the image code, which corresponds to the ticket for which the ticket cancellation request is received, from the supplier to the original purchaser who allotted the ticket. In this way, even if no purchaser shows up to purchase the ticket, the server 30 makes the original purchaser of that ticket to be the possessor of the image code corresponding to that ticket. As a result, the supplier does not incur any loss.

Furthermore, according to the second embodiment, if a notification for dropping the ticket cancellation request is received, the server 30 changes the mapping of the image code corresponding to that ticket from the supplier to the original purchaser who allotted that ticket. In this way, even if a notification for dropping the ticket cancellation request is received, the server 30 makes the original purchaser of that ticket to be the possessor of the image code corresponding to that ticket. As a result, neither the supplier nor the original purchaser incurs any loss.

Meanwhile, the server 10 or the server 30 can be implemented by installing the functions such as the control unit 12 and the memory unit 11 in an information processing device such as a known personal computer or a known workstation.

In the second embodiment, in a ticket transfer managing system 9A, the ticket selling website 3A includes the server 30 that manages the transfer of tickets. However, that is not the only possible case. Alternatively, the ticket transfer managing system 9A can be divided into a ticket transfer managing website, which includes the server 30 for managing the transfer of tickets, and the ticket selling website 3A, which includes the ticket reselling unit 202. In such a configuration too, the server 30 makes the ticket selling website 3A, which serves as the supplier, mediate for the trade of a ticket for which a ticket cancellation request is received. Hence, the server 30 can trade the ticket, for which a ticket cancellation request is received, without having to make the original purchaser, who had allotted the ticket, and the new purchaser directly communicate with each other.

Meanwhile, the constituent elements of the device illustrated in the drawings are merely conceptual, and need not be physically configured as illustrated. The constituent elements, as a whole or in part, can be separated or integrated either functionally or physically based on various types of loads or use conditions. For example, the ticket allotting unit 121, the QR returning unit 122, and the QR displaying unit 123 can be integrated into a single constituent element. In contrast, the ticket allotting unit 121 can be divided into a first allotting unit, which allots a ticket for the first time, and a second allotting unit, which allots a ticket for the second time onward. Moreover, the memory unit 11 that includes the management DB 111 can be connected as an external device to the server 10 or to the server 30 via a network.

Thus, according to an aspect of the present invention, the purchaser of entry tickets can uniquely manage the transfer of those entry tickets.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable non-transitory medium storing therein a transfer managing program that causes a computer to execute a process comprising:
generating, in response to a first request from a first user, first image code
storing the first image code in a memory in a manner corresponding to a second user;
generating, in response to a second request from the first user, second image code which is different from the first image code
storing the second image code in the memory in a manner corresponding to a third user;
controlling, in response to a third request from the first user that requires invalidating the first image code and validating the second image code; and
sending the second image code to the third user.

2. The computer-readable non-transitory medium according to claim 1, wherein the sending includes sending the second image code to the third user, when the first image code is invalidated and when the second image code is validated.

3. The computer-readable non-transitory medium according to claim 1, wherein
the sending includes sending the second image code to the third user without determining whether the first image code is invalidated and whether the second image code is validated.

4. The computer-readable non-transitory medium according to claim 1, wherein
the controlling includes invalidating the first image code and validating the second image code, when a returning approval indicating approval of returning the first image code is received from a terminal of the second user.

5. The computer-readable non-transitory medium according to claim 4, wherein
the controlling includes invalidating the second image code without the returning approval from the third user, when the second image code is validated but is not yet sent to the third user.

6. The computer-readable non-transitory medium to claim 1, further including,
when the second image code that is received from a reading device is valid, outputting new image code to an electronic device of the user who is linked to the second image code stored in the memory.

7. The computer-readable non-transitory medium according to claim 1, wherein
when, from a terminal of a user who is linked to valid image code, a ticket cancellation request to cancel the image code is received, the controlling includes changing mapping of the image code from the user who requested cancellation to a supplier, and
when, from a terminal of a new user who desires to use the image code, a request indicating the desire to use the image code is received, the controlling includes generating new image code, invalidating the image code for which the ticket cancellation request is received, and validating the new image code.

8. The computer-readable non-transitory medium according to claim 7, wherein
the controlling includes changing mapping of the image code, for which the ticket cancellation request is received, from the supplier to the first user, when a request indicating the desire to use the image code is not received.

9. The computer-readable non-transitory medium according to claim 7, wherein
the controlling includes changing mapping of the image code, for which the ticket cancellation request is received, from the supplier to the first user, when a request to drop the ticket cancellation request is received.

10. A method for managing transfer, the method comprising:
generating, in response to a first request from a first user, first image code
storing the first image code in a memory in a manner corresponding to a second user;
generating, in response to a second request from the first user, second image code which is different from the first image code
storing the second image code in the memory in a manner corresponding to a third user;
controlling, in response to a third request from the first user that requires invalidating the first image code and validating the second image code; and
sending the second image code to the third user.

11. A processing server comprising:
A processor; and
A memory unit, the processor including
generating, in response to a first request from a first user, first image code
storing the first image code in the memory unit in a manner corresponding to a second user;
generating, in response to a second request from the first user, second image code which is different from the first image code
storing the second image code in the memory unit in a manner corresponding to a third user;
controlling, in response to a third request from the first user that requires invalidating the first image code and validating the second image code; and
sending the second image code to the third user.
